(19) United States
(12) Patent Application Publication
(10) Pub. No.: US 2026/0012374 A1
(43) Pub. Date: Jan. 8, 2026

(54) SECURE COMMUNICATIONS USING PROTOCOL TRANSLATION

(71) Applicant: Infineon Technologies AG, Neubiberg (DE)

(72) Inventors: Alexander Zeh, Muenchen (DE); Kenneth William Tindell, Bury St. Edmunds (GB)

(21) Appl. No.: 19/241,646

(22) Filed: Jun. 18, 2025

Related U.S. Application Data
(60) Provisional application No. 63/667,383, filed on Jul. 3, 2024.

(51) Int. Cl. H04L 12/40; H04L 9/32

(52) U.S. Cl. CPC H04L 12/40104; H04L 9/3236; H04L 2012/40215

(57) ABSTRACT

The described techniques address issues related to compatibility and cost-effectiveness of in-vehicle networks. The described techniques may utilize security protocols such as MACsec, for example, without the need to exchange separate key agreement messages and, consequently, meet the stringent starting time requirements for real-time control systems. Additionally, the described techniques may utilize a security message translation process that translates the frames of different security protocols between one another. This translation process may map one or more parameters from one communication standard, such as an Ethernet standard, to one or more parameters defined by a different standard, such as a CAN bus standard. The techniques thereby allow for legacy devices such as CAN bus nodes to leverage the high security protocols used by costlier Ethernet Everywhere in-vehicle networks.

### CROSS-REFERENCE TO RELATED APPLICATIONS

This application claims priority to U.S. provisional application No. 63,667,383, filed on Jul. 3, 2024, the contents of which are incorporated herein by reference in their entirety.

### TECHNICAL FIELD

The disclosure generally relates to the use of secure data communications and, more particularly, to the use of secure communications that leverage locally stored key counter values in accordance with a real-time bus key distribution system to eliminate the need for dedicated key agreement messages, as well as to a protocol mapping solution that may ensure that existing bus architectures may be used to support secure (and unsecure) communications using other types of communication protocols.

### BACKGROUND

Controller Area Network (CAN), Controller Area Network Flexible Data-Rate (CAN FD), Controller Area Network Extra Long (CAN XL), and Ethernet communication protocols (e.g., 10BASE-T1S, 10BASE-T1L) are currently the dominant network/protocols implemented for use in automotive in-vehicle communications, which leverage an accompanying electrical/electronic (E/E) architecture. However, these conventional approaches have various drawbacks, particularly with respect to the communication overhead needed to distribute shared keys that are used to authenticate, encrypt, and decrypt secured messages within the network.

Additionally, in the automotive industry in particular there has been a push by automotive original equipment manufacturers (OEMs) with respect to “Ethernet everywhere” architectures. For instance, for such implementations, all software “sees” an Ethernet application programming interface (API) for in-vehicle networking (to support the Software Defined Vehicle concept). However, such Ethernet everywhere in-vehicle implementations suffer from various drawbacks, such as high costs.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1A illustrates the use of a conventional key agreement messaging protocol for low priority frames;

FIG. 1B illustrates the use of a conventional key agreement messaging protocol for high priority frames;

FIG. 2A illustrates an example node architecture, in accordance with one or more embodiments of the disclosure;

FIG. 2B illustrates an example key session generator, in accordance with one or more embodiments of the disclosure;

FIG. 2C illustrates an example received freshness value (FV) log, in accordance with one or more embodiments of the disclosure;

FIG. 3 illustrates an example system of interconnected nodes including defined secure zones, in accordance with one or more embodiments of the disclosure;

FIG. 4A illustrates an example format of a received secured message, in accordance with one or more embodiments of the disclosure;

FIG. 4B illustrates an example format of a transmitted secured message, in accordance with one or more embodiments of the disclosure;

FIG. 5 illustrates an example use of a hardware-based solution for utilizing freshness values, in accordance with one or more embodiments of the disclosure;

FIG. 6 illustrates an example hardware-based implementation for adapting the secured messaging system with an existing conventional system, in accordance with one or more embodiments of the present disclosure;

FIGS. 7A and 7B illustrate example process flows, in accordance with one or more embodiments of the disclosure;

FIG. 8 illustrates another example node architecture, in accordance with one or more embodiments of the disclosure;

FIGS. 9A-9C illustrates example process flows for translating between two different message frame formats, in accordance with one or more embodiments of the present disclosure;

FIGS. 10A-10H illustrate additional details regarding process flows for translating between two different message frame formats, in accordance with one or more embodiments of the present disclosure; and

FIGS. 11A-11B illustrate example process flows, in accordance with an embodiment of the disclosure.

The example aspects of the present disclosure will be described with reference to the accompanying drawings. The drawing in which an element first appears is typically indicated by the leftmost digit(s) in the corresponding reference number.

### SUMMARY

Again, conventional communication protocols and electrical/electronic (E/E) architectures have various drawbacks, particularly with respect to the processing power, overhead, and time required to generate the shared keys needed to ensure authentic and secure communications across the network. For instance, a typical E/E architecture used to communicate secured messages as further discussed herein may comprise a system of interconnected “nodes,” which may represent any suitable type of device within a network that is configured to transmit and receive secure messages, such as sensors, electronic control units, actuators, electromechanical components, etc. The number of interconnected nodes in such systems may be on the order of tens or hundreds, and each node may transmit secured messages to and receive secured messages from other nodes within the interconnected system.

The underlying network supporting the system of interconnected nodes may be implemented as part of any suitable type of system that utilizes secured communications, such as for example an in-vehicle network, industrial-based networks such as those used in production lines, etc. For example, an interconnected system of nodes may comprise groups of nodes that communicate securely via a connected broadcast bus to facilitate a real-time control system. Such a real-time control system may utilize the communication of sensor data, control data, or other data, and may comprise components that, in the event of a failure, may represent a significant safety risk. Thus, specific operating parameters need to be considered to ensure robust secure communications within such systems.

For instance, any of the nodes in such a real-time control system may reset at any time (e.g. if an internal watchdog timer is triggered), and all data in the node's volatile memory (RAM) is lost as a result. Moreover, after a node starts (or restarts), the node must be able to resume communications very quickly, i.e. within a few milliseconds, to receive and send messages (e.g., sensor data, actuator commands, etc.) to and from other nodes on the bus. Furthermore, messages must be protected against tampering by an attacker, and potentially must also be encrypted to prevent an attacker from seeing the contents of the message. A node should also be protected against replay attacks (i.e., where an attacker takes a copy of a message sent on the bus and then transmits it again later to attempt to cause receiving nodes to act upon it). Additionally, the cryptographic systems for secure messaging must change keys when they become “exhausted” (i.e., have been used too often), and each group of nodes engaged in secure communications need to agree on the same values of a replacement key.

To this end, it is noted that secured messages are generated by a node prior to transmission via the use of one or more shared keys, which may also be referred to as shared secrets or secret keys, and generally do not change over the lifetime of the nodes. The shared keys are typically stored in the local memory of each node and provided as an input to a cryptographic block, which implements a cryptographic function such as a key derivation function (KDF). The cryptographic block also receives an input in the form of a counter value, which may change over time, as well as any other suitable inputs that are used to ensure a uniqueness of keys generated in this manner. The cryptographic block may thus output, for each set of inputs which includes at least the shared key and a counter value, one or more session keys, which may be used for the authentication and/or encryption of the secured messages. Thus, when symmetric encryption is implemented, the node(s) receiving the secured message utilizes the same session key(s) as the node that transmitted the secured message.

However, the shared keys and the session keys should not be transmitted unencrypted (i.e., in the clear) as doing so poses a significant security risk by exposing the pre-shared keys to potential attackers. Thus, to prevent the transmission of keys in the clear, conventional communication protocols and E/E architectures utilize a system referred to as key agreement. This process ensures that the nodes involved in secure communications agree to use the same session key (by means of a key agreement protocol) and, when the key is exhausted or otherwise needs to be updated, the nodes agree on a new session key. Thus, for a node that has restarted and forgotten all details of previous keys, the node cannot replay messages using an old session key.

Thus, a monotonically increasing sequence number is typically used to prevent replaying messages where the key has not changed, which may alternatively be referred to as a freshness value (FV). This is accomplished via the current Ethernet standard MKA (MACsec Key Agreement) protocol, e.g. the IEEE Standard for Local and Metropolitan Area Networks-Port-Based Network Access Control IEEE 802.1X. However, this introduces issues when implemented as part of secure, real-time control systems. Specifically, the protocol takes too long to complete, and a node that has restarted has to wait far too long for a consensus to be established on a new session key before the node can once again receive and send secure messages (i.e., a large number of messages must be exchanged between a group of nodes and a central key server).

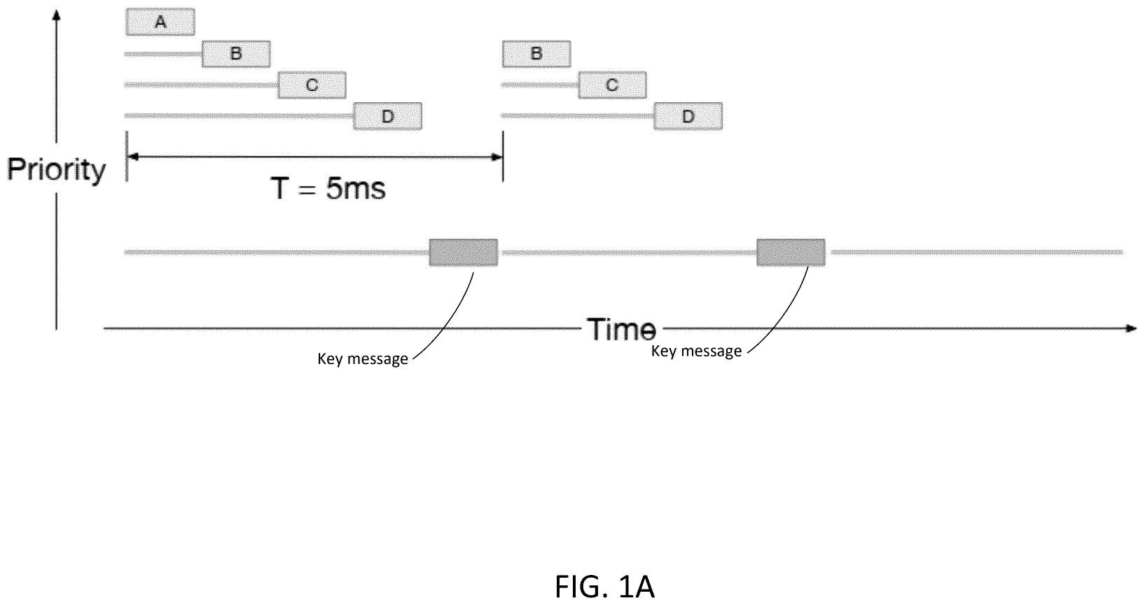

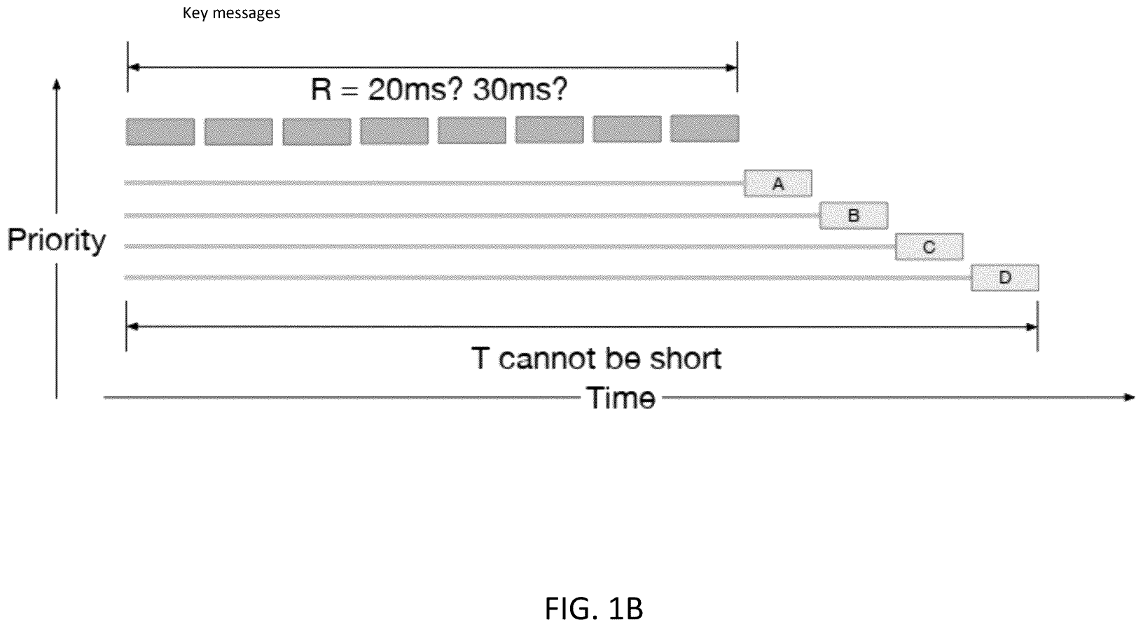

Thus, and as addressed in further detail in Section I, and as described with respect to FIGS. 1A and 1B, blocks A, B, C, and D represent high priority frames in accordance with a key agreement communication protocol, such as Media Access Control Security (MACsec) for example, such as that described in the IEEE Standard for Local and Metropolitan Area Networks: Media Access Control (MAC) Security, IEEE 802.1AE for instance. Upon a disruption in communications, e.g., when a node is reset, the key messages need to be transmitted from each node to other nodes in the system to ensure a synchronization among all nodes in a group. Thus, the blocks at the bottom of FIG. 1A represent the key distribution messages when the secure messages are a lower priority. In this case, it is shown that secure communications cannot occur between the nodes B, C, and D until a new key message is distributed to each of the nodes B, C, and D. This adds latency to the secured communications and is thus undesirable for the communication of lower priority secured messages. This also introduces an issue for higher priority communications, as shown in FIG. 1B. Specifically, FIG. 1B illustrates the introduction of latency as a result of the need to distribute the key messages to each of the communicating nodes A, B, C, and D. Thus, conventional key agreement protocols are not suitable for nodes connected on a broadcast bus for use in real-time control systems, as such latency may introduce significant safety risks.

The embodiments as further described in Section I are directed to addressing this issue by achieving key agreement without the need to exchange separate key agreement messages and, consequently, meets the stringent starting time requirements for real-time control systems. This is achieved, as discussed in further detail below, using a group-wide key counter, with each node storing in its non-volatile memory the latest value of this counter that was observed via the last received secured message. This counter value increases monotonically, and nodes maintain synchronization by transmitting this counter value (or a representation of the counter value) in each secured message.

The counter (or portions thereof) may alternatively be referred to herein as a key counter or key number (KN) because it is used (along with a pre-shared key, also stored in non-volatile memory) by the cryptographic block to derive one or more session keys, as noted above. Because different nodes in a communication group may utilize the same the cryptographic function, the same key counter and the same shared key yield the same session key. As a result, when nodes synchronize to the same group-wide key counter, the nodes are in effect agreeing to use the same session key.

Again, each secured message includes the key counter or, more precisely, a representation (e.g., a portion of bits) of the key counter to enable receiving nodes to establish the group-wide key counter value using their local copies, which again are stored in non-volatile memory. This facilitates key agreement because the key counter changes infrequently. Thus, the inclusion of a portion of the key counter, such as a lower predetermined number of truncated bits, is sufficient for each receiving node to verify whether the counter value used by the transmitting node (and sent in the secured message) matches the locally stored key counter at the receiving node. And because the key counter representation is carried in every secured message, there is no need for any separate key agreement messages. In other words, the key agreement is implicit in every secured message, and therefore no delay results from waiting for a consensus of agreement among nodes, as is the case for conventional systems.

Additionally, and as noted above, Ethernet Everywhere architecture implementations have drawbacks, particularly with respect to their high costs, and there have been continuing efforts to make 10BASE-T1S (10 Mbit/sec multidrop bus Ethernet) more cost effective. Such industry efforts are projected to take considerable time, and therefore the embodiments described in this Section focus on the use of an existing bus system (e.g. CAN bus) to manage a transition to Ethernet Everywhere solutions.

Therefore, in Section II, embodiments are discussed that provide a protocol mapping solution to ensure that existing CAN bus architectures may be used to support any other suitable types of communication protocols. These mapping solutions function to map one or more parameters between different protocols by translating specific parameters (e.g. values within data fields) between them to maintain compatibility. This may be particularly advantageous, for instance, to leverage the security protocols that are defined and used in accordance with non-CAN bus protocols (e.g. Ethernet-based MACsec protocols) without requiring the use of an Ethernet network that would general otherwise be needed for typical Ethernet Everywhere solutions. Furthermore, the embodiments are discussed in Section II may enable the use of heterogeneous scenarios between Ethernet and CAN using the same security protocol.

In other words, the embodiments presented in Section II may ensure that existing CAN bus architectures may be used to match the security level provided by Ethernet-based MACsec protocols (as well as higher-layer protocols) without requiring the use of an Ethernet network that is used for typical Ethernet Everywhere solutions. The embodiments described in further detail in Section II may be implemented for any suitable type of application. Thus, although described in some examples as generating secured messages and/or extending the concepts described in Section I, these are by way of example and not limitation.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

The embodiments herein are presented in two separate Sections for ease of explanation. Section I is directed to the use secure communications that leverage locally stored key counter values that eliminates the need for dedicated key agreement messages. Section II is directed to the transparent use of security protocol translation, which enables existing in vehicle network (IVNs) architectures such as CAN bus networks to leverage various security protocols such as Ethernet-based MACsec. Although these embodiments are discussed separately, it is noted that any of the embodiments described in either Section I or Section II may be implemented separately or combined with one another, and any of the architectures, communication protocols, and/or techniques described in Section I are also applicable to the embodiments described in Section II, and vice-versa. For example, any of the embodiments as described herein with respect to Section I may optionally be implemented using the communication protocol translation embodiments as described in Section II.

### I. Secure Communications Leveraging Locally Stored Key Counter Values

As discussed in further detail below, the embodiments described herein may be implemented in accordance with any suitable communication architecture that leverages a broadcast bus to facilitate secured communications among a system of interconnected nodes. The broadcast bus may be implemented, for instance, in accordance with what is referred to as a “multi-drop” scheme. In other words, although the embodiments described herein may function in accordance with a point-to-point communication architecture, the embodiments may be particularly useful for use in a point-to-multipoint communication architecture. Furthermore, although not limited to use in real-time control systems, the embodiments described herein may advantageously be implemented as part of such systems, which require heightened considerations with respect to security, timing, and robustness compared to conventional node-based communication networks.

For instance, and using a vehicle-based real-time control system as one example, the nodes in such real-time control systems may control safety-critical components such as vehicle steering, braking, acceleration, etc. As a result, it is crucial that secured messages between these nodes be sent and received with little latency, that nodes come back online quickly after being reset, and that nodes in the system are not adversely impacted while waiting for reset nodes to come back online. Moreover, due to the increased considerations with respect to safety and to resist reverse engineering attempts, a real-time control system needs to be resistant to malicious attacks, which may attempt to gain unauthorized access to keys or other system information.

For example, one such attack includes so-called “replay attacks,” which force secured messages to be re-sent to other nodes out of order. To guard against such attacks, conventional systems utilize a “freshness value” (FV) to prevent replaying the same (legitimate) message to force receivers act on it at an invalid time. These conventional systems, which include the controller area network (CAN) bus and multi-drop Ethernet communication protocols such as 10BASE-T1S and 10BASE-T1L, results in out-of-order frames being transmitted due to priority queueing. Thus, such conventional systems have adopted an “acceptance window,” although this still allows for replay attacks but confines such attacks to a window to attempt to limit this possibility. However, the primary disadvantage of such a system is that the window may be relatively large (e.g., 1 second), and as a result this reduces but does not eliminate the possibility of exposure to replay attacks.

Other attacks include denial of service attacks using the key agreement messages. As noted above, the use of conventional key agreement protocols requires a substantial number of such messages to be transmitted within the network, which scales quadratically with the number of nodes. It is thus possible to exploit the use of such a large number of messages to maliciously trigger a key re-agreement process to cause bus traffic to be disturbed. Moreover, such attacks may be used to trigger multiple key re-agreements to cause secure traffic to stop altogether.

Additional attacks include the re-use of secure channel indicator (SCI) values, the details of which are further discussed herein, to break assumptions about nonce re-use. For instance, a malware-infected node may use SCI values assigned to another node and force the device to send messages that could re-use a nonce value, implicitly leaking the session key. Still further, attacks may include denial of service attacks on a key agreement server, which may drive the server offline with a bus off attack, thereby preventing the server from issuing new keys.

The embodiments described herein address these issues to increase the robustness of real-time control systems to such attacks. To do so, the embodiments as further described herein do not utilize key agreement messages, and instead may operate independently of a key agreement server. Thus, instead of using a centralized key agreement system, the embodiments as described herein may maintain a locally stored copy of the counter values that would conventionally be derived from a central server. Again, a representation of the counter value may be transmitted as part of each secured message, which may be used by a receiving node to validate the counter and verify the secured message.

### A. An Example Node Architecture

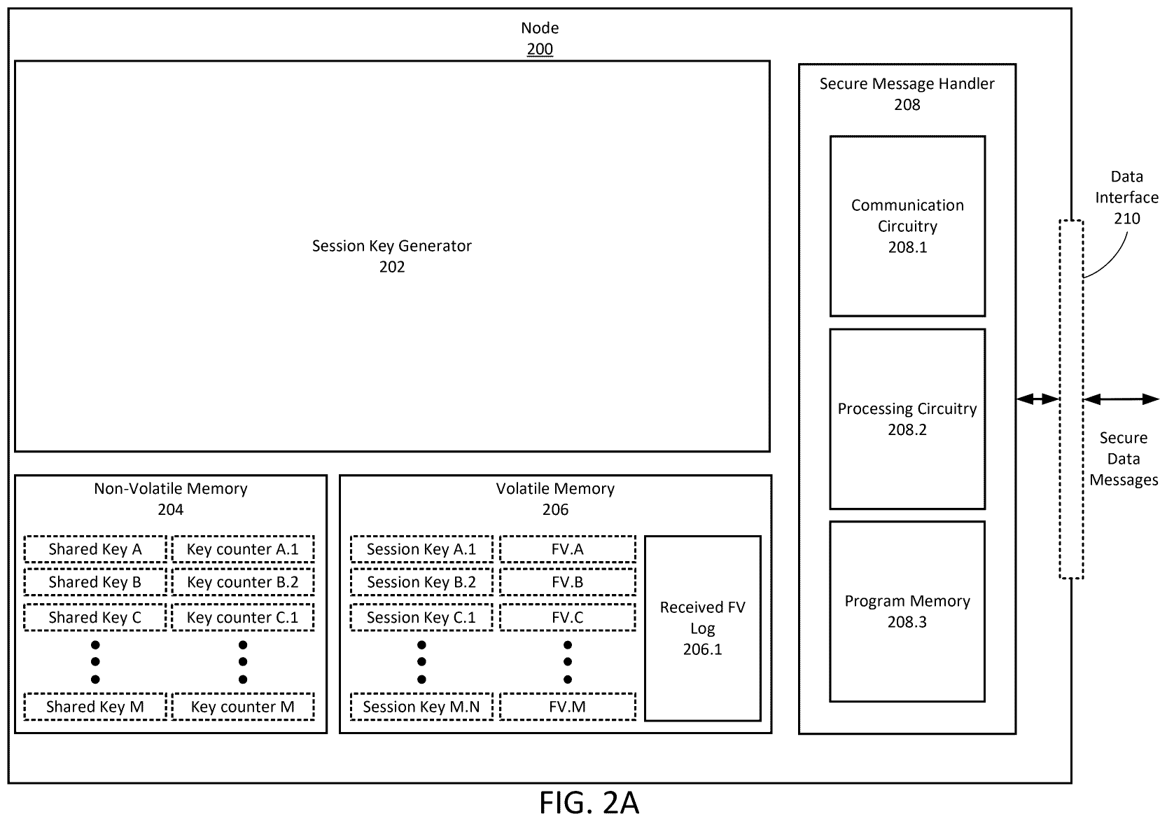

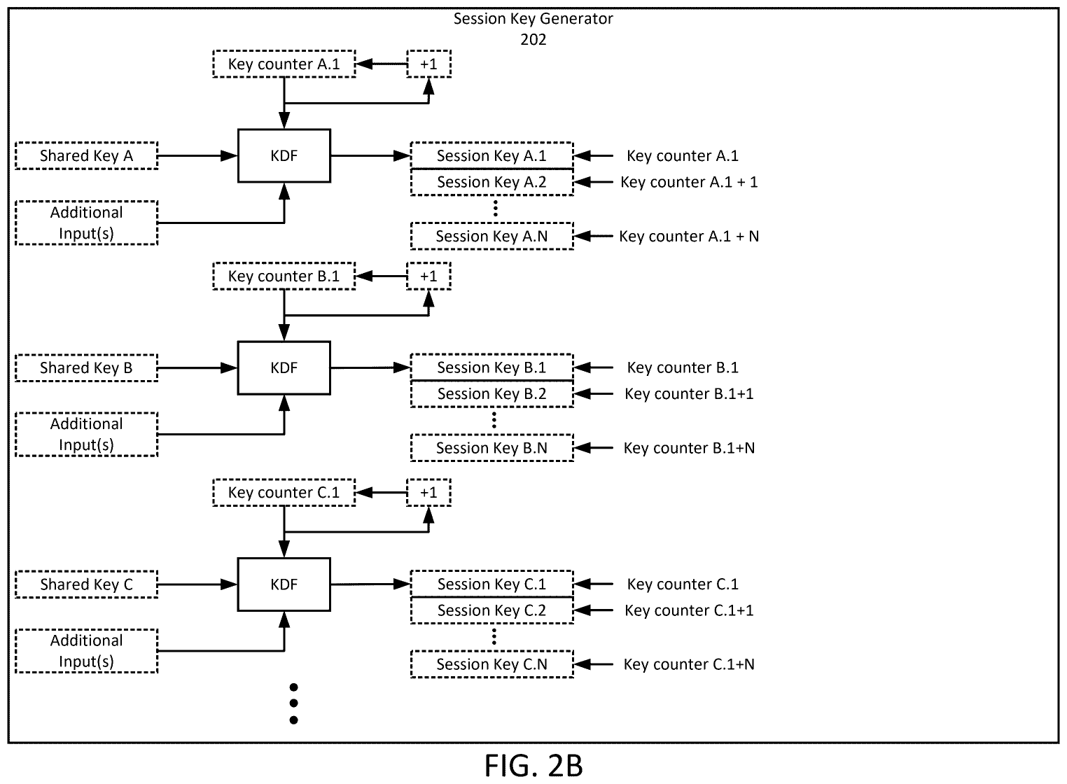

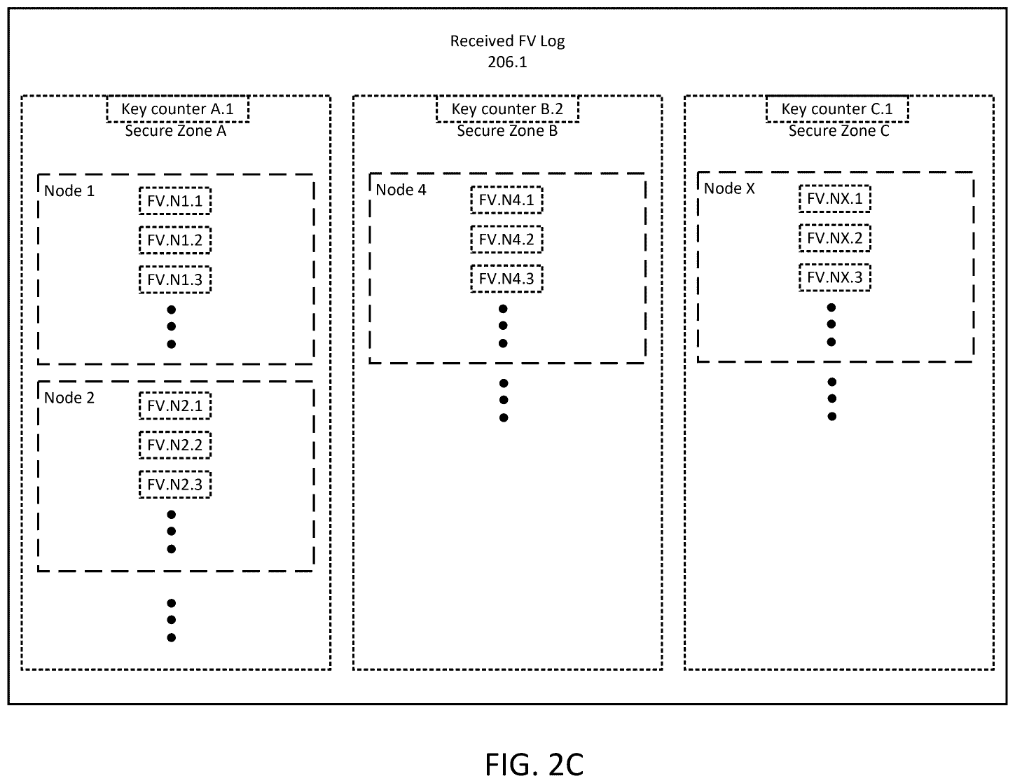

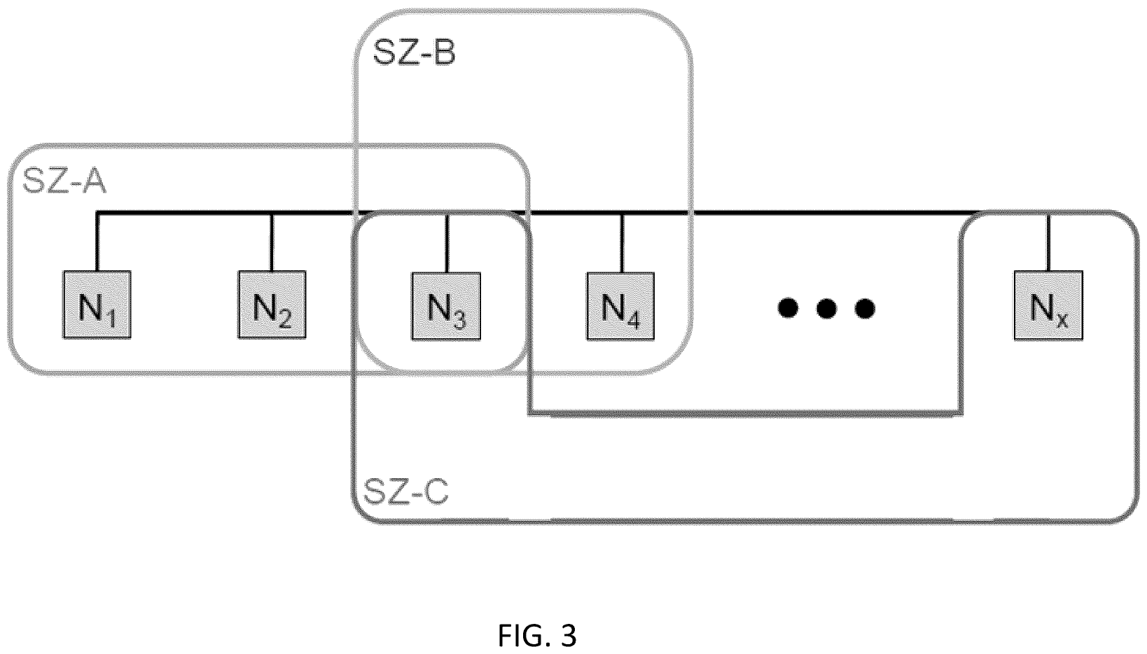

FIG. 2A illustrates a node architecture, in accordance with one or more embodiments of the disclosure. The node 200 may be identified with any suitable type of component, and may represent one node in a system of interconnected nodes, with such a system being illustrated in FIG. 3 and further discussed below. For example, the node 200 may be identified with part of an electronic control unit (ECU), a sensor, an actuator, a host, etc. The various nodes with such an interconnected system may differ in type and/or function, although each node may have a common functionality as discussed herein with respect to the node 200. Thus, each node in the system of interconnected nodes may be configured to transmit and/or receive secured messages in the same manner as that described herein with respect to the node 200.

The node 200 as shown in FIG. 2A may represent one node in the system of interconnected nodes configured to communicate over a bus according to a multi-drop scheme, as discussed herein. Such a multi-drop scheme may for, for example, be part of an in-vehicle E/E architecture as discussed above, which may include a CAN bus architecture or other suitable in-vehicle E/E architecture. The system of interconnected nodes may support the communication of secured messages in accordance with any suitable type of system, such as a real-time control system that may be implemented in a vehicle. Thus, the node 200 may be one of any suitable number of nodes that communicate with one another by transmitting and receiving secured messages via the data interface 210, which may be coupled to and/or form part of a bus that is used as part of any suitable type of point-to-point or multi-drop scheme. The data interface 210 may comprise any suitable number and/or type of data interface(s) to facilitate the exchange of secured messages between the node 200 and any suitable number of other nodes within the system of interconnected nodes.

The node 200 may transmit and/or receive secured messages as discussed herein to communicate with other nodes within the system of interconnected nodes using any suitable number and/or type of communication protocols and accompanying modes of operation. For instance, the node 200 may be configured to receive secured messages and to transmit secured messages in accordance with communication protocols that utilize the authenticated-encryption Galois/Counter Mode (AES-GCM) or AES-GCM-SIV of operation, the Counter with CBC-MAC Modes (CCM) of operation, communication protocols that utilize modes of operation implementing the ShangMi 4 (SM4) cipher, any suitable type of Ethernet communication protocols (e.g. multi-drop Ethernet communication protocols such as 10BASE-T1S, 10BASE-T1L, the Ethernet MACsec standard, etc.), any suitable in-vehicle network protocols such as a Controller Area Network (CAN) communication protocol, Controller Area Network Flexible Data-Rate (CAN FD) communication protocol, a Controller Area Network Extra Long (CAN XL) communication protocol, any suitable communication protocols that implement Authenticated Encryption with Associated Data (AEAD) modes of operation, etc.

Again, the node 200 (as well as every other node in the interconnected system) is configured to transmit secured messages to other nodes and to receive secured messages transmitted by other nodes via the data interface 210. Thus, although each node in the interconnected system of nodes (which again includes the node 200) is configured to perform both transmitting and receiving functions, the term “transmitting node” is used herein when referring to any node that is currently performing the transmission of a secured message and/or performing any functions related to such secured message transmissions, whereas the term “receiving node” is used herein when referring to any node that is currently receiving a secured message and/or performing any functions related to such secured message receptions.

To perform secure message communications, the node 200 comprises a session key generator 202, a non-volatile memory 204, a volatile memory 206, and a secure message handler 208. These components are illustrated in FIG. 2A as being separate entities, with their corresponding functions being described separately for ease of explanation. However, any of the components of the node 200 may be integrated or otherwise combined with one another. The node 200 may also comprise additional or alternative components as those shown and discussed herein with respect to FIG. 2A. Furthermore, although the node 200 is shown and described herein with respect to the use of the non-volatile memory 204 and volatile memory 206, this is by way of example and not limitation. Any of the data stored in the non-volatile memory 204 and volatile memory 206 may be additionally or alternatively stored in other memories, which may be part of the node 200 or components external to the node 200. For example, any of the data that is illustrated in the Figures as being stored in a volatile memory may alternatively be stored in a non-volatile memory, and vice-versa. However, it is recognized that specific types of static data, such as the secret keys, may advantageously be stored in non-volatile memory to ensure their security. Further it may be of interest to assure persistence of static data, such as secret keys, in the event that a node goes offline and returns to the bus, as may be the case with a reboot of a node.

Furthermore, the node 200 is shown and discussed herein with respect to performing the functions of both secured message transmission and reception, although it will be understood that the node 200 may comprise separate components to perform each respective function, or alternatively comprise a combination of such components to selectively implement both functions independently of one another. Thus, the secure message handler 208 may represent an encoder, a decoder, or a combination of both an encoder and decoder to facilitate the node 200 operating in accordance with any of these aforementioned modes of operation.

The secure message handler 208 may comprise any suitable number and/or type of components, with an example of such components being shown in FIG. 2A by way of example and not limitation. For instance, the secure message handler 208 may comprise communication circuitry 208.1, which may be coupled to the data interface 210 and thus the accompanying bus of the system of interconnected nodes as discussed herein. Thus, the data interface 210 may comprise any suitable implementation of components for this purpose, such as for instance wires, buses, and/or respective terminals, ports, pins, etc. The communication circuitry 208.1 may be implemented as any suitable hardware components that enable communications between the node 200 and other nodes within the system of interconnected nodes, as further discussed herein, via the data interface 210. Thus, the communication circuitry 208.1 may transmit secured messages to the data interface 210 and receive secured messages from the data interface 210 in accordance with any suitable number and/or type of communication protocols, such as those discussed herein. To do so, the communication circuitry 208.1 may comprise hardware components, software components, or combinations of these, which are typically associated with components configured to perform data communications. For example, the communication circuitry 208.1 may comprise any suitable number of ports, drivers, transmit and/or receive buffers, switches, etc.

The processing circuitry 208.2 may comprise any suitable number and/or type of dedicated hardware components such as a microcontroller, an application specific integrated circuit (ASIC), a field programmable gate array (FPGA), a system on a chip (SoC), dedicated logic and/or other circuitry, etc. The processing circuitry 208.2 may be implemented as one or more processors and/or cores, which may execute computer-readable instructions stored in the program memory 208.3 to perform any of the various functions as discussed in further detail herein. Thus, although the processing circuitry 208.2 is illustrated in FIG. 2A as a separate entity from the session key generator 202, it is understood that the processing circuitry 208.2 may facilitate the operations of the session key generator 202 as further discussed herein, and thus the session key generator 202 and the processing circuitry 208.2 may, in some embodiments, comprise the same component(s).

The program memory 208.3 may comprise any suitable type of non-transitory computer readable medium such as volatile memory, non-volatile memory, or combinations of these. To the extent that the node 200 implements software-based solutions to perform the various functions as discussed herein, this may be achieved, for instance, via the processor circuitry 208.2 executing instructions stored in the program memory 208.3.

### B. Secure Zones

Again, the node 200 may represent one of several nodes that form a system of interconnected nodes. FIG. 3 illustrates an example of such a system of interconnected nodes, which comprises a total of X nodes. The node 200 may be identified with any of the nodes N₁-N_{X}, and each of the nodes N₁-N_{X} may transmit and receive secured messages in a similar manner as the node 200 as discussed herein.

The system of interconnected nodes 300 (also referred to herein as simply a system 300) may include any suitable number of secure zones (SZ), with three being shown in FIG. 3 for purposes of brevity, which are represented as the secure zones SZ-A, SZ-B, and SZ-C. These secure zones may be defined in accordance with any of the communication protocols as discussed herein, and nodes with the system 300 may identify the intended recipients of secured messages transmitted and received within these secure zones via the use of a secure channel indicator (SCI) field, as discussed in further detail below.

With continued reference to FIG. 3, each one of the secure zones in turn comprises a respective group of nodes. For example, the secure zone SZ-A of the system 300 as shown in FIG. 3 comprises the nodes N₁, N₂, and N₃. The secure zone SZ-B comprises the nodes N₃ and N₄, and the secure zone SZ-C comprises the nodes N₃ and N_{X}. The embodiments as discussed herein may implement the transmission and reception of secured message in accordance with a particular secured zone within which the transmitting node and the intended recipients of the secured message form a part. However, the embodiments are not limited to their use with a system comprising such secure nodes, and may be realized as part of any suitable communication system, i.e., with or without the use of secure zones.

### C. Key Generation and Management

To enable the use of secured messages, the node 200, as well as every other node in the system 300, stores a set of shared keys, on a secure zone basis when secure zones are utilized. In other words, each node in the system 300 stores a shared key, which may be alternatively referred to as a secret key or a shared secret, in a non-volatile (NVM) memory. Turning now to FIG. 2A, this is illustrated by way of the node 200 comprising a non-volatile memory 204, which is configured to store a shared key for each secure zone in which the node 200 is a member within the system 300. Thus, the node 200 may be identified with the node N₃ as shown in FIG. 3 for ease of explanation, as the node N₃ is a member of each of the secure zones SZ-A, SZ-B, and SZ-C. Thus, the node 200 in this case stores three shared keys A, B, and C, in the non-volatile memory 204. Of course, the node 200 may store additional or fewer shared keys based upon the number of secure zones in which the node 200 is a member. Therefore, in an embodiment, each node is configured to store, in its non-volatile memory, any suitable number M of shared keys, with M being greater than or equal to the number of secure zones to which the node is a member. For instance, the node 200 may store one shared key per secure zone, as shown in FIG. 2A, although this is by way of example and not limitation, as the node 200 may store any suitable number of shared keys per secure zone.

Thus, the NVM 204 may be implemented as any suitable type of non-volatile memory having any suitable size for storing any suitable number of shared keys. Each of the shared keys may represent a predetermined bit string or other suitable encoded numeric value having any suitable length. Each node within the same secure zone thus stores the same shared key in its respective NVM, which is used for the transmission and reception of secured messages for that secure zone, but not for other secure zones. For example, the nodes N₁, N₂ may only store the shared key A for secure zone A, whereas the node N₂ may only store the shared key B for secure zone B. The secret key is generally static and does not change over the operational life of a node, and thus may be flashed, written to, stored, etc., as part of an initial manufacturing process. Alternatively, the shared keys may be written to the NVM 204 via the node 200 or another suitable device. To ensure security, the shared keys are not included in the secured messages that are communicated between the nodes and are only be accessed or otherwise known by each node via its respective NVM, and thus is unknown to other nodes in the system 300.

In any event, the “permanent” shared keys are used to facilitate the generation of temporary session keys, which may be referred to herein simply as session keys, and are used for transmitting and receiving secured messages within the same secured zones. To do so, reference is now made to FIG. 2B, which provides additional details with respect to the session key generator 202 as shown in FIG. 2A. The session keys are generated using a key derivation function (KDF), which represents a specific cryptographic function in accordance with the particular communication protocol that is implemented by the node 200. The use of KDFs are generally known, and thus additional detail regarding KDF operation is not described herein for purposes of brevity.

Like the shared keys, the session keys may represent a bit string or other suitable encoded numeric value having any suitable length. In any event, once generated, the processing circuitry 208.2 may use a respective session key per secure zone to generate each secured message that is transmitted to other nodes within the same secure zone, and also use this same session key to authenticate and/or decrypt secured messages received from nodes within the same secure zone. Thus, the processing circuitry 208.2 may execute any suitable type of cryptographic function that utilizes, as a cryptographic key, the generated session keys to generate the secured messages.

Additionally, it may be particularly advantageous to implement one session key for authentication purposes and a second one for encryption purposes at one node, as some cryptographic functions require distinct keys for authentication and encryption. It is further noted that, in some alternative implementations, an individual session key may be assigned to individual nodes participating in a secure zone. In such a scenario, for each secured message, the key derivation function (KDF) may be performed (i.e., transmit and/or receive). In particular, for an implementation of the KDF via hardware, this may be performed without penalty.

It is noted that the session key generator 202 may implement any suitable type of KDF to generate any suitable number of session keys from each respective shared key. That is, the session key generator 202 is configured to generate, for each one of the secure zones, a respective temporary session key using a respective shared key and a respective key counter value in accordance with a respective cryptographic function. Moreover, for the transmission of a secured message each group of nodes within a secure zone, each respective secured message comprises a plurality of fields, as further discussed herein, with one of the fields comprising a representation of the respective counter value used to generate the session key used to generate the secured message. Additional detail regarding the content and format of the secured messages is discussed further below.

The communication circuitry 208.1 is also configured to transmit secured messages to each group of nodes in accordance with the secured zone to which each recipient node belongs. Therefore, although multiple session keys may be generated from a single shared key, the same session keys are used to perform secured communications to and from nodes within the same secured zone at any one time. Thus, for communications to nodes within each secure zone, the KDF receives as inputs the shared key for that secure zone as well as a counter value. Each KDF may also receive additional inputs as shown in FIG. 2B, which may be any suitable values that are selected to ensure the generated session keys are unique per secure zone. For example, the additional inputs to the KDF may comprise an SCI value, a nonce (number used only once), etc. As a result, the same shared key may be used to generate multiple session keys per zone by modifying a different input to the KDF in each case.

In any event, it is noted that the same KDF algorithm will repeatedly generate the same session key from the same inputs. Thus, and as will be described in further detail below, other nodes may be configured with the same KDFs and shared keys to authenticate and/or decrypt secured messages using their own session keys and inputs, which should then match the session keys used when the secured message was generated by the transmitting node (i.e., prior to being received by the receiving node).

Although the session keys are described herein as being used to transmit secured messages to all other recipient nodes per secure zone, this is by way of example and ease of explanation. Specifically, the session keys as described herein may be implemented to generate secured messages that may represent authentication only messages or, alternatively, both authentication and encryption messages. For example, for the various AES-GCM-based protocols (which is used in MACsec), an integrity check value (ICV) is computed in accordance with their respective algorithms. For authentication only secured messages, the ICV is computed without encrypted data, and for authenticated and encrypted secured messages the ICV is computed in parallel with the encrypted data. Authentication only messages may be particularly useful, for example, in scenarios in which a message needs to be read first to quickly perform a specific control or execute a command without first decrypting the payload of the secured message. The embodiments as discussed herein may implement any suitable algorithms to compute the ICVs, including known techniques. In accordance with these cryptographic functions used to generate the ICV, the inputs typically comprise a key (e.g. the session key), a counter value (e.g. the key counter value), the plaintext of the message (when present), and a current freshness value (FV) that is transmitted in the secured message.

In any event, based upon the particular cryptographic algorithm that is used to compute the ICV, the ICV may be generated using the same key as that used for the encryption of data (i.e. the encrypted payload) or a different key. In either case, the keys used for the generation of the ICV and for data encryption may comprise the transmitting node's locally stored session keys, which again may comprise the same session keys or different session keys, in various embodiments, which are identified with the key counter(s) for a specific secure zone. Thus, for authentication purposes, a transmitting node may utilize its locally stored session key to compute the ICV, whereas for authenticated and encrypted secured messages the transmitting node may use its locally stored session key(s) to compute the ICV and the encrypted payload. For both secured message types, the ICV is verified via the receiving node to establish authentication of the secured message, as further discussed herein.

Thus, embodiments include any suitable number of session keys being generated from the same shared key and KDF, with a different key counter value (or other different inputs) being used to generate each different session key in this manner. Alternatively, the session key generator 202 may generate any suitable number of different session keys per secure zone using the same inputs and KDF, but a different shared key, to thereby generate each different session key in this manner.

To provide an illustrative example, the session key generator 202 may be configured to generate, from each respectively stored shared key, two respective temporary session keys in accordance with the same cryptographic function. Thus, the same key counter value may be used to generate different session keys from the same shared key by varying other inputs to the KDF. Continuing this example, a first one of the temporary session keys generated in this manner may enable a receiving node to decrypt the secured message, whereas a second one of the temporary session keys generated in this manner may enable a receiving node to authenticate the secured message. In other words, the nodes within each secure zone may function in accordance with a predetermined scheme such that specific session keys are used for authentication, encryption, or both authentication and encryption, of secured messages.

Again, one variable with respect to generating different session keys from the same shared key is the key counter value, which may also be referred to herein as a counter value. Thus, each receiving node needs to ensure that its session key has been generated with the same key counter value as the transmitting node, or else the receiving node will be unable to authenticate and/or decrypt the secured message. In this way, the embodiments described herein advantageously enable nodes to synchronize their key counter values, and thus their session keys, without the use of key messages.

Thus, it is prudent to now provide additional detail regarding the conventional use of the key counter values. It is noted that conventional systems use a centralized server, control plane, host, etc., to maintain a global counter value, which needs to be communicated with the nodes as discussed above as part of the key agreement messages. However, the embodiments of the present disclosure recognize that the session keys may alternatively be maintained and derived locally, obviating the need for communications with a centralized entity for key agreement.

To do so, each node in the system 300 may comprise any suitable number of counters, with one per shared key as shown in FIG. 2B. The counters may be implemented as any suitable hardware components, software components, or combinations of these, which enables the generation of unique counter values that may be represented as any suitable number of bits. Each counter may be implemented, for example, to generate a monotonically increasing counter value that is incremented in response to one or more predefined conditions being satisfied, which may be the result of a “re-keying” event. Such a re-keying event may occur, for example, in response to any suitable number of conditions, which may be voluntary or triggered by a security alert. For example, a node may perform a re-keying when a number of secured messages are transmitted with a respective session key in excess of a predetermined number of messages (i.e., session key “exhaustion”), the expiration of a predetermined time period, each system boot, etc. To provide another example, the re-keying conditions may comprise a security alert that may be detected by a centralized server, another node, a host processor, etc. The security alert may be sent to the node 200 via the data interface 210 or other suitable data interface, and explicitly instruct the node 200 to perform a re-keying process.

Thus, the processing circuitry 208.2 of the node 200 may periodically perform a re-keying process in accordance with the various conditions as discussed above. In an embodiment, the processing circuitry 208.2 may implement a rate-limiter that is configured to limit the number of re-keying operations within a particular time period. This may include, for example, a prioritization-based system that may be implemented via the node 200. Such a system may account for watchdog reset loops, for example, and comprise the storage of one or more priority flags in the NVM 204, the presence of which overrides the triggering of the re-keying process. For example, the non-volatile memory may store such a flag, which is indicative of some event that, when present, overrides the re-keying process. Thus, while the flag is stored in the NVM 204, the processing circuitry 208.2 will not perform a re-keying operation despite any of the aforementioned conditions being met. The priority flag may be cleared after the passage of a predetermined time period, once the event has ended, etc., such that the key counter is not incremented while the priority flag is set.

In some embodiments, the processing circuitry 208.2 may implement (e.g. via execution of instructions stored in the program memory 208.3) a stable storage algorithm, which may alternatively be referred to as an atomic storage algorithm, to perform the re-keying process. Stable storage is a classification of computer data storage technology that guarantees atomicity for any given write operation and allows software to be written that is robust against some hardware and power failures. To be considered atomic, upon reading back a just written-to portion of the disk, a storage subsystem should return either the write data or the data that was on that portion of the disk before the write operations. Stable storage algorithms generally aim to eliminate corrupted data in storage. To do so, the data is stored more than once, or with an error correcting code, so that it is possible to always read the most recent non-corrupted value. The use of such a stable storage algorithm may be particularly useful to guard against a power failure or glitch during the incrementation process not resulting in a corrupted key counter value.

In such a case, the session key generator 202 stores the updated (i.e., incremented) key counter value in the non-volatile memory, e.g. by overwriting the previous key counter value for that shared key with a new key counter value. The session key generator 202 also generates, from the respective shared key and the incremented key counter value, an updated temporary session key in accordance with the KDF, as shown in FIG. 2B. Thus, the session keys are generated via the KDF from the shared keys and the current key counter values (as well as other inputs), with the shared keys and the counter key values both being stored in the NVM 204. As re-keying events may be secure zone specific, this is illustrated in FIG. 2A via the key counter for secure zone B being incremented, whereas the key counter values for secure zones A and C are not.

For example, and as shown in FIG. 2A, the NVM 204 may store any suitable number of key counter values, which are correlated to each of the stored shared keys. In this way, the NVM 204 stores, for each one of the secure zones, a respective shared key and a respective key counter value. That is, the key counter values may be different than one another among the different secure zones, although the value of each key counter may be synchronized among the nodes within each secure zone, as further discussed herein.

A representation of this key counter value may be included in each secured message in unencrypted form, i.e., “in the clear.” Therefore, and as discussed in further detail below, each receiving node may verify the validity of the key counter value based upon a comparison of the key counter value representation in the received secured message with the receiving node's locally stored key counter value. Because each node in the system 300 may store key counter values in this way, a receiving node may determine whether a counter value that is computed from the counter value representation contained in the secured message matches the locally stored counter value.

If not, then the receiving node may increment and overwrite its locally stored key counter value to match the counter value used to generate the session key and secured message, pending verification of the secured message as discussed in further detail below. That is, prior to updating the locally stored key counter value in this way, the receiving node may validate the key counter value represented in the secured message by generating a session key (via its session key generator) from the computed counter value (i.e., the counter value representation sent in the secured message). This temporary session key is then used at the receiving node to verify a corresponding integrity check value (ICV) contained in the secured message. In other words, the representation of the counter value in the secured message enables a receiving node to derive a temporary session key, which is used to validate the counter value used by the transmitting node to generate the session key that was used to generate the secured message. This process is described in further detail below.

Again, the session keys generated by the session key generator at any time are considered temporary, and may be changed upon the key counter values being incremented as noted above. Thus, the volatile memory 206 is configured to store each of the session keys generated via the session key generator 202. The temporary session keys may be overwritten or deleted as updated session keys are generated (e.g. upon the counter value being incremented), as discussed above.

The secured messages may also be transmitted with a representation of a sequence number. The sequence number may comprise, in some embodiments, a freshness value (FV), such as the freshness value that is defined in accordance with any of the communication protocols as described herein. However, although referred to herein as a freshness value, the sequence numbers are not limited to freshness values as defined in any specific communication protocol or standard, and may comprise a bit string or other suitable encoded numeric value having any suitable length, which may be used to enhance security measures by preventing a replay attack.

Thus, the freshness value is also a changing, temporary value, and thus the volatile memory 206 may also store the most recent freshness value for each transmitting node that is correlated to each session key (and in turn the key counter value), as shown in FIG. 2A. As a security measure, the processing circuitry 208.2 may increment the freshness value after each secured message is transmitted and after each secured message is received. That is, the freshness value may have an initial, predetermined value (e.g., 1) that is incremented by a transmitting node when each secured message is transmitted and is also incremented by a receiving node as each secured message is received.

It is noted that the secured messages may arrive at a receiving node out of order, i.e. the buffering scheme used by a transmitting node will typically send a higher priority message ahead of a lower priority one. Thus, conventional systems typically accept out of order messages, but use a “window” so replayed messages will need to be relatively recent, with the hope that this provides adequate protection against such attacks. Furthermore, conventional systems use multiple sequence numbers at each transmitting node (one for each secure channel) and then the transmitting node ensures that within each of its secure channels, the sequence numbers are transmitted in order.

Due to the use of key counter values as described herein, the embodiments as discussed herein extend this conventional use of the freshness values in several different ways. First, each receiving node stores a log of previously received freshness values that were contained in previously received and accepted secured messages, which are correlated to each transmitting node, secure zone, and current key counter value. The number of logged freshness values stored in this manner may be any suitable number depending upon the particular application.

Additional details regarding the log of received freshness values are shown in FIG. 2C, which illustrates that each key counter value is correlated with its previously received freshness value numbers for each transmitting node and per secure zone. Thus, the received FV log 208.1 as shown in FIG. 2C includes one set of logged freshness values per node, because each of the nodes is part of only one secure zone in this example. However, this is by way of example and not limitation, and the received FV log 208.1 may store any suitable number of freshness values for each transmitting node based upon the number of secure zones within which each node is a member. For example, if the node N₄ was also a part of the secure zone A, then the received FV log 208.1 would also store a log of freshness values received from node N₄ via the secure zone A (not shown).

Thus, the receiving node uses the freshness value in each received secured message to determine whether a current secured message from a specific transmitting node has already been received. To do so, the receiving node references the stored set of logged freshness values for that particular transmitting node, which may be identified via the transmitted SCI value, as further discussed below. In the event that a new received secured message does not have a freshness value greater than the last recorded freshness value, then the secured message is discarded as a replay. It is noted that the first secured message received is always accepted by the receiving node, i.e. prior to the history of previously received freshness values being available.

Second, when the local key counter value is changed (i.e. during a re-keying process in which the key counter value is incremented), the transmitting node resets the freshness value (for the particular secure zone for which the key counter was reset) to an initial, predetermined value (e.g. 1). The receiving node is configured to recognize the initial freshness value in a secured message that is received after such an event occurs. Thus, after a re-keying event occurs, the receiving node may continue to store any suitable predetermined number of the last received freshness value for previously-used key counter values so that older secured messages still working their way through the priority queues (and hence with old counter values) are still validated even after the receiving node has moved on to using a new key counter value. Alternatively, freshness values stored in this manner may be deleted after a predetermined time period has elapsed upon using a new key counter value. In this way, a receiving node may still receive and accept secured messages across a rekeying event, and will accept the first message transmitted after a re-keying process has occurred.

The freshness values may serve different purposes for both the transmitting and receiving nodes. For instance, a transmitting node may compare the incremented freshness value after transmitting a secured message to a predetermined freshness value threshold to determine whether a threshold number of secured messages have been transmitted, thereby triggering the re-keying process as noted above. For example, because the transmitting node generates and stores a different session key for each secure channel, the transmitting node may use the freshness value to count messages using the session key, i.e. a number of secured messages transmitted per session key. When the freshness value for a particular secure zone reaches a predetermined threshold value, the transmitting node may increment the key counter as part of a re-keying process as noted above.

Thus, the predetermined threshold value may comprise a value per node or a value that represents a sum across any suitable number of nodes, such as those within the same secure zone, for instance. In other words, when the same session key is in use across all other transmitting nodes in the same secure zone, a quota may be established for this threshold such that the quota for all nodes in the secured zone sums to less than an exhaustion count (i.e. the predetermined threshold value) for the session key.

In an embodiment, the exhaustion counter may be implemented using the transmitting node ID (or SCI) in the KDF used to generate the session keys, such that there are unique session keys for each transmitting node. In this case, a transmitting node's exhaustion count may be identified with the use of its own session key, which reduces the number of re-keying processes because the quota is not shared among several nodes.

Thus, the KDF implemented by the session key generator 202 may optionally receive, as part of the additional inputs as shown in FIG. 2B, a secure channel identifier (SCI), which is unique across the system. The concept of a secure channel, and the carrying of a secure channel identifier, is part of the Ethernet MACsec standard as well as other communication standards, and is further discussed below.

### D. Secured Message Format and Communication Protocol

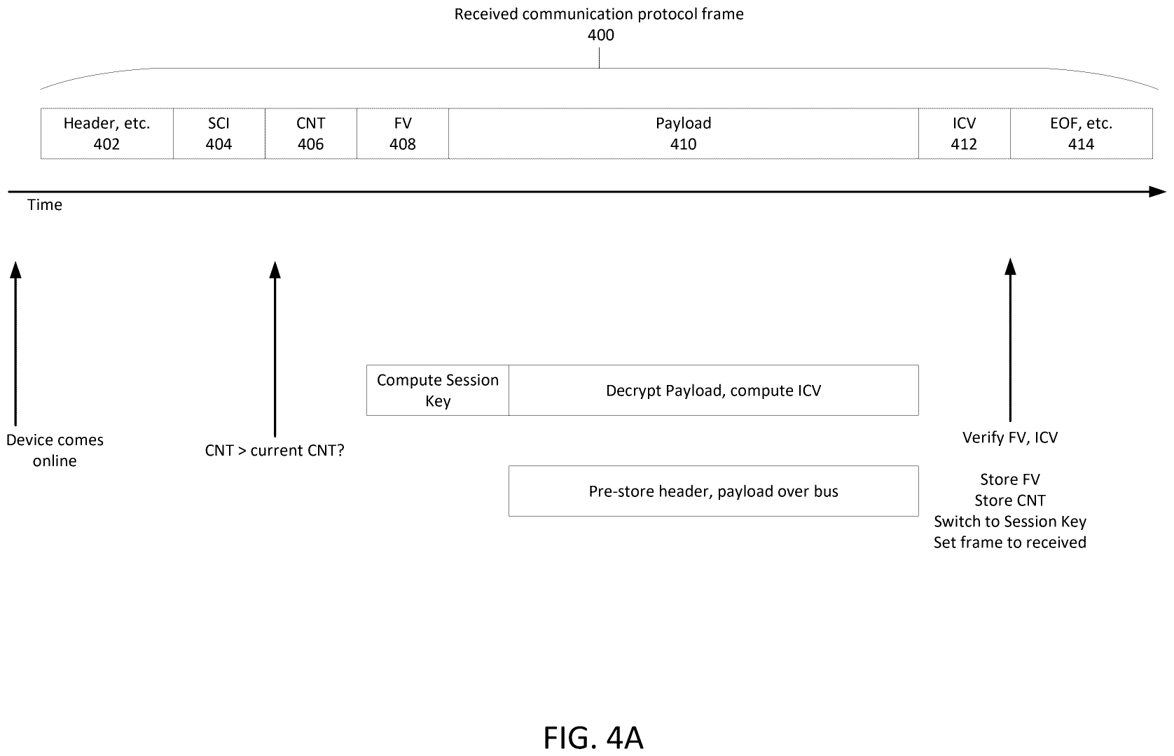

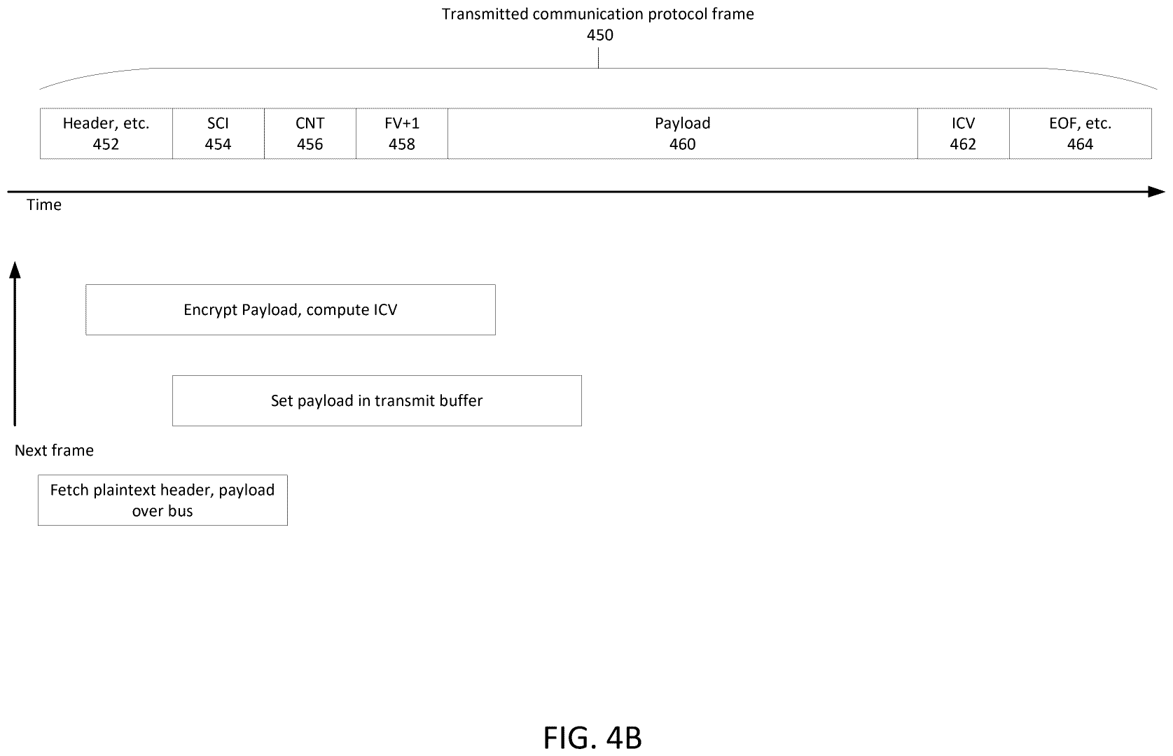

FIG. 4A illustrates a secured message format and accompanying processing timeline, in accordance with one or more embodiments of the disclosure. The secured message as shown in FIG. 4A may be transmitted in accordance with any suitable communication protocol, and may constitute a communication protocol frame 400 comprising any suitable number of fields. Again, the communication protocol, and thus the accompanying communication protocol frame 400 as shown in FIG. 4A, may be identified with any suitable type of communication protocol that may be implemented to facilitate the communication of secured messages via a multi-drop bus architecture. For instance, the communication protocol frame 400 may be identified with a CAN communication protocol frame, a CAN FD communication protocol frame, a CAN XL communication protocol frame, an Ethernet (e.g., multi-drop Ethernet such as 10BASE-T1S, 10BASE-T1L) communication protocol frame, a FlexRay communication protocol frame, a local interconnect network (LIN) communication frame, etc.

In any event, the communication protocol frame 400 may be identified with a secured message that is generated by a transmitting node using a temporary session key for a specific secure zone, as discussed herein with respect to the node 200. The communication protocol frame 400 may include additional, fewer, or alternate fields as shown in FIG. 4A. For example, the communication protocol frame 400 comprises a header 402, an SCI 404, a representation of the counter value (CNT) 406 used to generate the secured message, a freshness value 408, a payload 410, an ICV 412, and an end-of-frame (EOF) identifier 414. The communication protocol frame 400 may be subsequently received by a receiving node as a secured message, which is either accepted or rejected, as further discussed below.

A secure channel within a secure zone comprises a single writer and multiple readers, and thus identifies a secure zone comprising nodes within the system of interconnected nodes that are intended recipients of a secured message. An SCI value may be identified via various communication protocols, such as for instance the security standard for the CAN XL communication protocol and the Ethernet MACsec standard. For example, according to the MACsec standard, the secure zone is defined by the shared key, and that SCI is used to identify a transmitting node. For example, the SCI may be used as one of the inputs to the KDF to generate unique session keys for each transmitter.

Each secure channel is thus identified with a respective SCI, and is unique in the physical and logical network. Thus, the secure zones SZ-A, SZ-B, and SZ-C as shown in FIG. 3 are each defined by a separate and unique SCI. The processing circuitry 208.2 of the node 200 is configured to generate the secured message having comprising an SCI value that indicates which one of the secure zones for which the secured message is intended, i.e. the SCI identifies the secure channel and, in turn, the recipients within the secure zone to which the message is transmitted. The communication protocol frame (also referred to herein as messages, communication frames, or simply as frames) 400 is assumed to be received by a receiving node that is in the same secure zone as the transmitting node, which again is indicated via the SCI value. Another use for the SCI to avoiding the window problem for out of order freshness values. That is, different SCIs can be used for different priorities so that they are in-order within the same SCI (and therefore the FV is attached to an SCI rather than a transmitting node). The SCI may also be used at the application level to identify a subgroup of receiving nodes within a secure zone.

The representation of the counter value 406 (also referred to herein as CNT 406) may comprise the entire key counter value that was used by the transmitting node to generate the session key or, alternatively, a truncated portion of the key counter value. For instance, the CNT 406 may comprise a predetermined number of lower significant bits (e.g., 4, 6, 8, etc.) of the full length key counter value that the CNT 406 represents.

Thus, a receiving node (e.g. the processing circuitry 208.2) may determine whether its local key counter value stored in the NVM 204 matches the CNT 406 by comparing either the entire stored key counter value for the secure zone as indicated by the SCI or, alternatively by comparing the truncated portion of the CNT 406. Comparing only the truncated lower significant bits of the counter value in this way is sufficient because the key counter value does not change frequently, e.g. only in response to the re-keying conditions as noted herein.

Continuing this example, if the receiving node's locally stored key counter value is determined to match the key counter value derived from the CNT 406, then the receiving node may retain its locally stored key counter value as is, determine that the key counter value represented by CNT 406 is valid, and accept the secure message. Additionally or alternatively, the receiving node may determine that the key counter value represented by CNT 406 is “provisionally” valid when the receiving node's locally stored key counter value is determined to match that derived from the CNT 406, i.e. subject to further verification processes.

For example, the processing circuitry 208.2 of the receiving node may be configured to validate the key counter value represented by the CNT 406 by verifying the secured message in various ways. Thus, upon verification of the message, the key counter value derived from the CNT 406 is determined to be valid, and thus the secured message is accepted. The verification may include, for example, the receiving node calculating a session key from the key counter value that is derived from the CNT 406. Thus, the session key that is generated in this manner should match the session key used by the transmitting node to generate the secured message, and should also match the session key stored locally at the receiving node when the key counter value that is derived from the CNT 406 matches the receiving node's locally stored key counter value. Thus, the verification of the message may be performed by the receiving node via the use of the session key that was generated from the key counter value derived from the CNT 406, which is used to decrypt contents of the secured message to derive and verify an ICV, as discussed in further detail below.

However, if the receiving node's locally stored key counter value is less than the key counter value derived from CNT 406, this means that the locally stored key counter value is out of date, and the receiving node executes a re-keying process to update the locally stored key counter value by overwriting the current key counter value with a new key counter value that matches the key counter value represented by CNT 406. Additionally, for the session keys associated with the current secure zone (as indicated via the SCI), upon verifying the validity of the counter value via the ICV check process described above, the receiving node generates an updated session key from the updated key counter value and overwrites its previously stored session key with the updated one, which should now match the session key used by the transmitting node to generate the secured message.

In other words, the processing circuitry 208.2 of the receiving node is configured to update the locally stored key counter value to match the computed key counter value derived from CNT 406 when the locally stored key counter value is less than the locally stored key counter value, but to not update the locally stored key counter value when the two key counter values already match one another. Thus, and as further discussed below, validating the key counter value represented by CNT 406 may comprise verifying the secured message based upon processing one or more fields of the secured message. This may comprise, for instance, using either a currently stored session key or generating an updated session key from the corresponding shared key stored in the receiving node's non-volatile memory, as the case may be, and then using the session key (or the updated session key, as the case may be) for secured message verification, as discussed in further detail below.

Furthermore, if the receiving node's locally stored key counter value is determined to be greater than that derived from the CNT 406, then the receiving node may retain its locally stored key counter value as is, conditionally determine that the key counter value represented by CNT 406 is invalid, and conditionally reject the secured message. Thus, the processing circuitry 208.2 of the receiving node is configured to determine that the key counter value represented by the CNT 406 is invalid, and to conditionally reject the secured message when the key counter value that is computed from the CNT 406 is less than the locally stored key counter value, as this is indicative of a replay attack, a stale message, or a corrupted message.

The conditional rejection of the key counter value is discussed further below, and may include, for example, a further determination regarding whether the key counter value derived from the CNT 406 in the secured message is nonetheless within a predetermined time frame, which may alternatively be referred to herein as a “grace period.” This grace period may represent, in some embodiments, a predetermined time period (e.g. 500 ms, 1 second, etc.) such that old key counter values are accepted within the grace period. Thus, the grace period may represent an age of the derived key counter value since the last (different) key counter was received. Additionally or alternatively, the grace period may be determined based upon a number of freshness values associated with the derived key counter value. In this way, communication is not interrupted for a specified period of time after a re-keying event has occurred. However, once the grace period has lapsed, messages with old derived key counter values may be rejected, thereby reducing the risk of replay attacks.

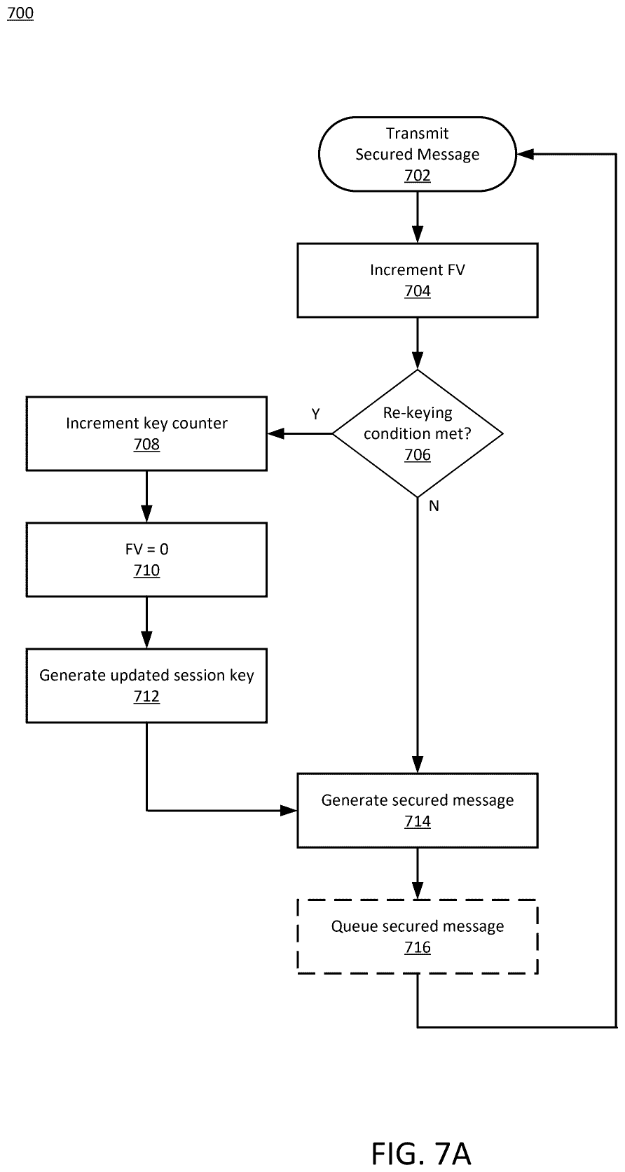

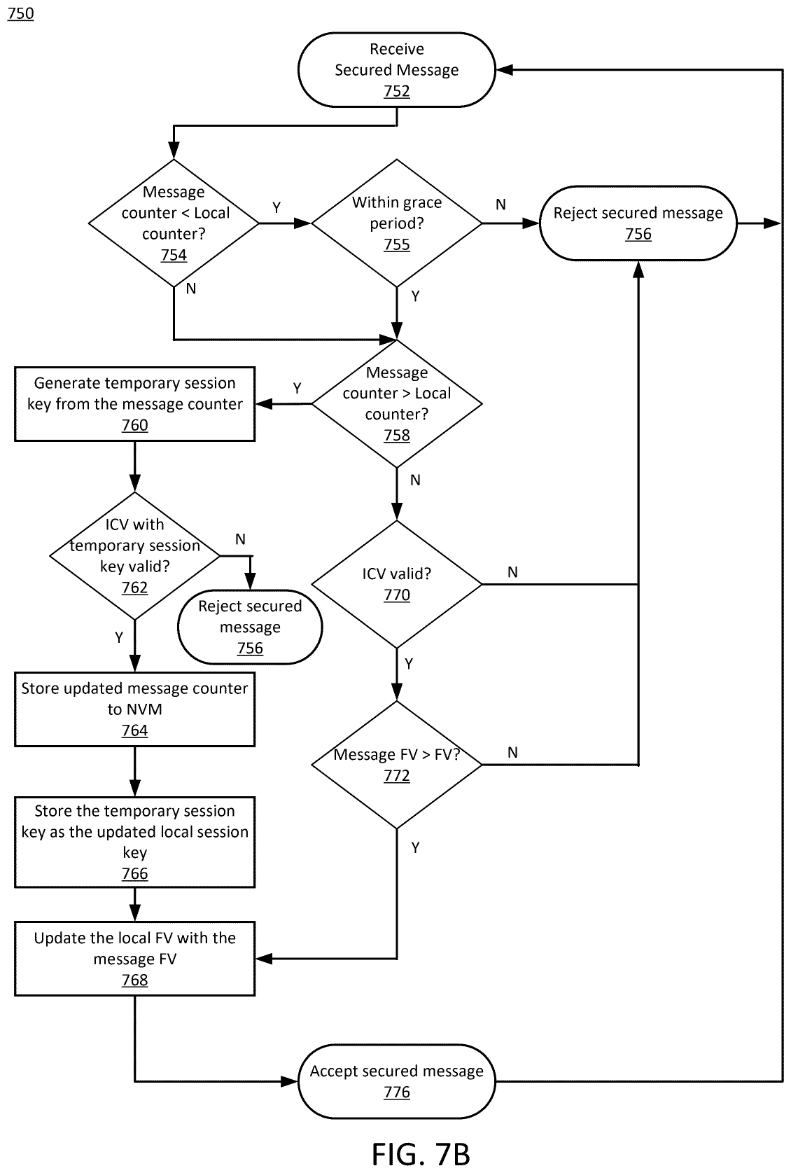

Thus, in each case, the receiving node either accepts or rejects the secured message based upon the determined validity of the key counter value that is computed from the CNT 406. Again, the secured message verification process implemented by the receiving node may utilize additional techniques to perform the key counter value validation to determine whether to accept the message. For example, the secured message may contain a sequence number field, which is shown in FIGS. 4A and 4B as the freshness value (FV) 408, 458. The freshness value may also be included in unencrypted form as part of the secured message, as further discussed herein. The representation of the freshness value, which may alternatively be referred to herein as the FV 408, may comprise the entire freshness value that is used by (and stored by) the transmitting node when generating the secured message or, alternatively, a truncated portion of the freshness value such as a predetermined set of lower significant bits. Thus, a receiving node may, as an added layer of security, verify whether the freshness value in a received secured message matches the freshness value stored in the receiving node's volatile memory (i.e., after the FV is incremented upon receiving the secured message). If not, then the message may be discarded, as the secured message may be part of a replay attack and/or the secured message has been sent out of order. Additional details regarding the use of the freshness values are discussed below with respect to FIGS. 7A and 7B.

The payload 410 may be encrypted via the processing circuitry 2080.2 of the transmitting node using the session key. This encryption process may be performed in accordance with any suitable cryptographic function, including known cryptographic functions. Again, in various scenarios, the secured messages as discussed herein may comprise authentication only messages or may comprise authenticated and encrypted messages. The payload 410 may thus comprise either plaintext that is part of an authentication only message (or be omitted), or alternatively, data that has been encrypted via the transmitting node, i.e. ciphertext.

Moreover, the communication protocol frame 400 comprises a field containing an ICV 412, which is generated by the processing circuitry 208.2 of the transmitting node. The ICV may be computed in accordance with any suitable techniques, including known techniques defined in accordance with any of the communication standards as discussed herein. For example, the ICV may comprise a bit string of a predetermined length, which is computed by the processing circuitry 208.2 based upon any suitable cryptographic function such as a Hash-based Message Authentication Code (HMAC) for example or other suitable function such as e.g. a Cyclic Redundancy Check (CRC). The ICV may thus be computed by executing an appropriate cryptographic function, as noted above, using, as inputs, the current key counter value and/or the plaintext of the payload 410. The ICV may comprise data representing a dedicated field or data representing a combination of data from other fields of the secured message 400 as shown in FIG. 4A for example. For instance, the ICV may comprise any suitable combination of the header 402 (including a security tag), the full key counter value represented by CNT 406, the plaintext payload 410 or the ciphertext payload 410, etc.

The ICV 412 may be transmitted as part of the secured message in the clear, although the payload 410 needs to first be decrypted by the receiving node to compute and verify the ICV with the same cryptographic function with which the ICV 412 was generated by the transmitting node. To do so, the receiving node may compute the session key (for that particular secure zone) using the locally stored key counter value corresponding to the computed key counter value derived from the CNT 406. Again, these key counter values (either initially or upon re-keying) should match one another when the key counter value derived from the CNT 406 is valid. In other words, and as noted above, the receiving node's stored key counter value may already match that used by the transmitting node, or may be updated to match that used by the transmitting node via the receiving node performing a re-keying process to update its key counter value, as the case may be.

In any event, once the receiving node generates a temporary session key from the key counter value computed from the CNT 406, this should match the session key used by the transmitting node to generate the secured message prior to being received at the receiving node. This generated session key should also match the locally stored session key at the receiving node assuming that the key counter value used by the transmitting node to generate the secured message generated is the same as that stored locally in the receiving node. That is, because the same KDF, key counter value, and shared key are used by the transmitting node and receiving node, this will yield identical session keys being output in each case. The receiving node may then use the generated temporary session key to decrypt the payload 410, and utilize the same cryptographic function as that used by the transmitting node to compute the ICV. The receiving node may thus compare the ICV computed in this way to the ICV 412 to determine that the computed key counter value derived from the CNT 406 is valid, and to thereby verify the secured message when the ICVs match, and thus accept the secured message. The receiving node may reject the message when the ICVs do not match, as the secured message is not verified, and thus the key counter value is not validated.

FIG. 4B illustrates another secured message format and accompanying processing timeline, in accordance with one or more embodiments of the disclosure. The secured message format as shown in FIG. 4B is identical to that shown in FIG. 4A with respect to the message format and fields. Thus, each of the fields 452, 454, 456, 458, 460, 462, and 464 may be identified with the same analogous fields 402, 404, 406, 408, 410, 412, and 414 of the secured message as shown in FIG. 4A. However, the secured message format as shown in FIG. 4B may be identified with a subsequent secured message that is transmitted by the receiving node as discussed above after receiving the secured message as shown in FIG. 4A. Thus, upon receiving and accepting the secured message as shown in FIG. 4A, the receiving node may store the freshness value (or a portion thereof) in its volatile memory, as discussed above and with respect to FIG. 2C. The receiving node may then increment this freshness value when transmitting a subsequent message and store this incremented freshness value in its volatile memory as well, as shown in FIG. 2A. This is illustrated in FIG. 4B by way of the FV+1 field 458.

Thus, the receiving node may become a transmitting node and transmit the secured message as shown in FIG. 4B. To do so, the (now) transmitting node may access from its volatile memory a session key in accordance with the current key counter value and secure zone corresponding to the recipient node(s) of the transmitted secured message. As part of this process, the transmitting node may compute the ICV and encrypt the payload to generate the payload 460. The transmitting node also computes the current SCI based upon the secure zone of the recipient node(s) of the secured message, as well as the counter value representation CNT 456, which is based upon the current key counter value used to compute the session key for that particular secure zone, as discussed above. Once the information for each of these fields is computed, the transmitting node then assembles and transmits the secured message, as discussed above, with the process being repeated as needed for each of the receiving nodes in the system 300.

### E. Hardware Implementation Examples

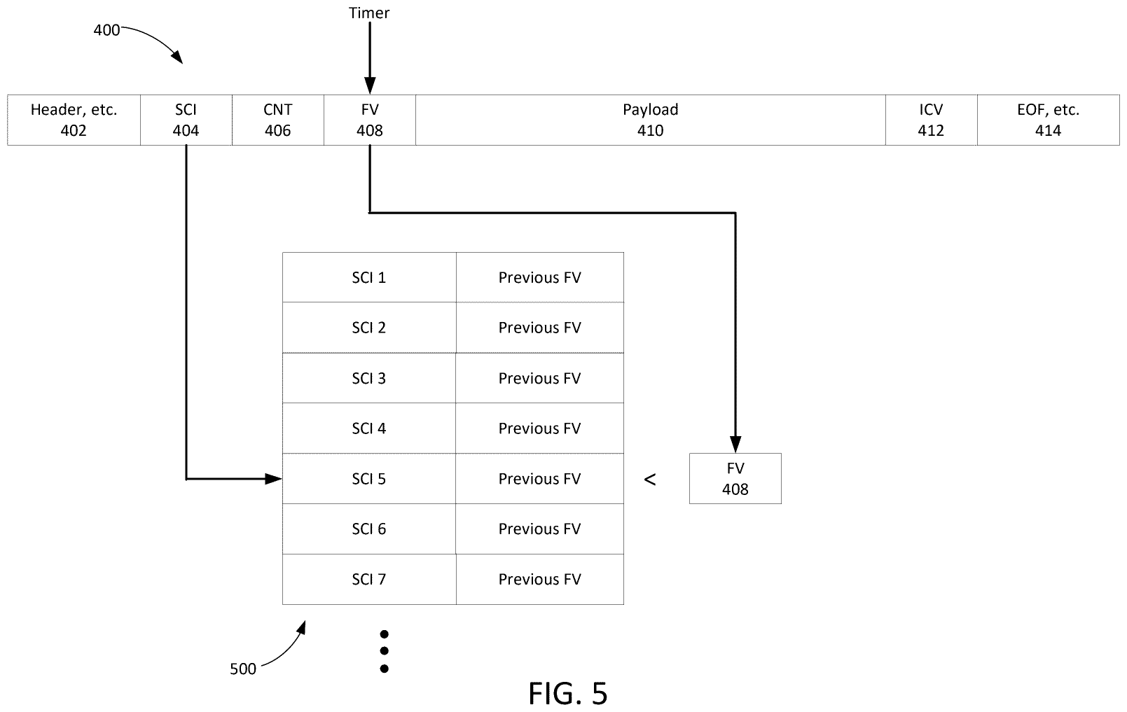

FIG. 5 illustrates the use of a hardware-based solution for utilizing freshness values, in accordance with one or more embodiments of the disclosure. FIG. 5 shows the communication protocol frame 400 from FIG. 4A, which includes a plurality of fields. The communication protocol frame 400 is identified with a secured message generated via a transmitting node. It is noted that if the freshness values are generated as noted above via a software-based approach, the transmitting node may re-order secured messages, which are then received out of order by each of the receiving nodes. Although the window of acceptance with respect to replay attacks may allow for receiving nodes to accept such messages, the use of a software-based approach consumes considerable processing overhead.

Thus, the solution described with respect to FIG. 5 enables a transmitting node to alternatively generate the secured messages “on the fly,” as opposed to being buffered and reordered, which is the conventional manner in which secured messages are transmitted. To do so, the transmitting node may implement any suitable type of timer mechanism. For example, each transmitting node may utilize a timer that references a tick time that represents a predetermined timer value, such as 10 microseconds, 5 microseconds, etc. Thus, the freshness value may still represent a string of bits, but these bits may comprise a binary representation of a number of “ticks,” with each tick corresponding to a predetermined tick time. This obviates the need for the transmitting node to store the freshness values for each secured message that is transmitted, as shown in FIG. 2A, assuming that the timer ticks faster than the message transmission time. In this regard it is noted that a freshness value in any event should not be re-used for two messages. Thus, the freshness value as discussed herein may be implemented generally as any suitable type of monotonically increasing counter, and as discussed with respect to FIG. 5 may comprise for example a tick timer, a single sequence number counter, etc.

The use of the timestamp for the FV may advantageously support a system in which secured messages are not re-ordered by the buffering scheme at the transmitting node, and therefore the transmitting node only needs one secure channel. This may be the case, for example, when secured messages are generated upon their transmission (i.e. done in hardware linked to a communications protocol engine). This reduces the storage and processing overhead associated with multiple secure channels. In this way, the hardware-based solution allows for a simplification of the SCI to a single, fixed channel on the transmitting node side, as the use of the timestamp ensures that the FV is always increasing per secured message.

Thus, for the hardware-based solution as shown in FIG. 5, the transmitting node may utilize a fixed SCI value that corresponds to a unique device address for that particular transmitting node. This SCI value is thus unique across the system 300. As a result of this modification, the receiving node may additionally or alternatively store, in its non-volatile memory 204 and/or the volatile memory 206 as shown in FIG. 2C, data as shown in the table 500. For example, the table 500 represents a mapping of SCI values (i.e., unique transmitting node addresses) to previously transmitted freshness values (i.e. timestamps). The table 500 may be stored in the form of a lookup table to facilitate such a hardware based solution. The table 500 may include a unique SCI value corresponding to each transmitting node from which the receiving node is configured to receive secured messages, with 7 being shown in FIG. 5 for purposes of brevity, as the table 500 may store any suitable number of SCI and FV values for received encoded messages based upon the particular application.

The receiving node may thus implement a hardware-based solution (e.g., via processing circuitry 208.2) that is configured to scan the data entries in the table 500 until a matching SCI value is found for the SCI 404. For this table entry (i.e., SCI 5 in this example), the table should contain a previous freshness value that is less than the current FV 408. If the FV 408 is less than the corresponding previous FV in the table 500 for SCI 5, then the receiving node may reject the message as it is likely to be a replay attack. It is noted that if the table is not large enough store the requisite number of entries, then further matching may be offloaded for software management (e.g., using a hash table).

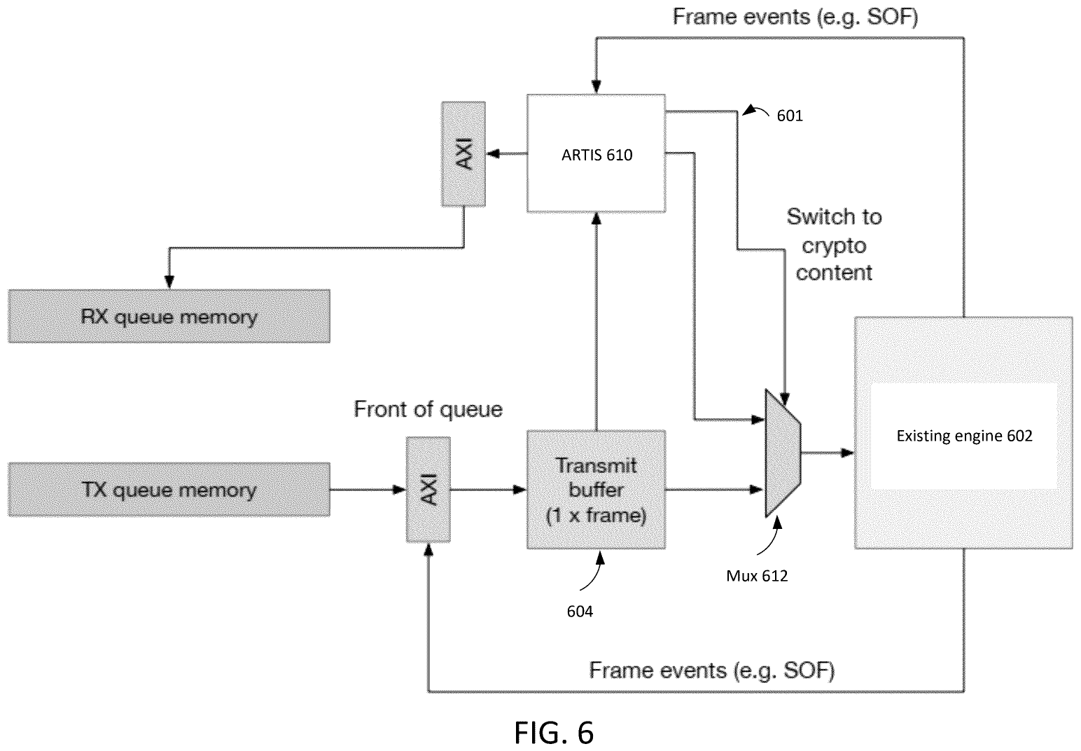

FIG. 6 illustrates another hardware-based implementation for adapting the secured messaging system with an existing conventional system, in accordance with one or more embodiments of the present disclosure. The architecture 600 as shown in FIG. 6 demonstrates that the embodiments as described herein are protocol agnostic. That is, the use of the counter value representations within secured messages and the session keys as discussed herein may be implemented independently of an existing architecture and communication protocol. For example, the architecture 600 comprises an existing engine 602, which may comprise any suitable type of conventional communication engine for use with a real-time control system. Some examples of the existing engine 602 may comprise a CAN bus engine, an Ethernet protocol engine, etc., as well as any of the communication protocols as discussed herein. Although a single engine is shown in FIG. 6, the architecture 600 may comprise any suitable number of different engines concurrently, e.g. a CANbus engine and an Ethernet engine.

The architecture 600 is implemented an Advanced eXtensible Interface (AXI) bus architecture by way of example, and also comprises TX and RX plaintext queue memories for buffering transmitted messages that are communicated within the particular system in which the existing engine 602 is implemented. Conventionally, the existing engine 602 controls the AXI coupled to the TX queue memory and the transmit buffer 604. Thus, the existing engine 602 is configured to receive messages from the transmit buffer 604 and to transmit these messages with an unencrypted payload in accordance with any suitable communication protocol, such as those discussed herein for example. Moreover, the existing engine 602 is typically coupled to the AXI and the RX queue memory directly, and thus the existing engine 602 may provide received messages with unencrypted payloads to the RX queue memory for delivery to other nodes in the system.

However, the architecture 600 additionally comprises an accelerated real-time security (ARTIS) engine 610, as well as a multiplexer 612. The ARTIS 610 may be implemented as any suitable dedicated hardware components such as a microcontroller, an application specific integrated circuit (ASIC), a field programmable gate array (FPGA), a system on a chip (SoC), dedicated logic and/or other circuitry, etc. The ARTIS engine 610 is configured to perform any or the functions as discussed herein with respect to the transmitting and receiving nodes, such as e.g. reading the key counter value representation contained in the secure messages, deriving the required session keys, performing encryption, authentication, and decryption, etc. The ARTIS 610 may advantageously be implemented in hardware versus software to eliminate the need for reordering secured messages and to thus minimize latency. This advantageously reduces the window for replay attacks to such a small time period that the risk for replay attacks is essentially eliminated.

The architecture 600 also comprises a multiplexer 612, which is controlled by the ARTIS engine 610 via the control signal 601. Thus, the ARTIS control engine 610 is configured to dynamically change the operation of the system in which it is implemented (e.g. system 300) between an unsecured and a secured messaging operation. For example, the lower path of the mux 612 may be selected to route plaintext data from the transmit buffer 604 to the existing engine 602, and the ARTIS engine 610 may also route the received plaintext data to the RX queue memory in this mode of operation.

However, the upper path of the mux 612 may be selected when operating in a cryptographic mode. In this mode, the plaintext messages are routed from the transmit buffer to the ARTIS engine 610, and are used by the ARTIS engine 610 to generate encrypted payloads that are included as part of the secured messages, as discussed herein. In this mode of operation, the secured messages are also routed to the RX queue memory and distributed to other receiving nodes in the system, but as secured messages (versus unsecured messages that are generated by the existing engine 602). In this way, the architecture 600 allows for concurrent operation of an existing, unsecured messaging system with the secured messaging system embodiments as discussed herein.

### F. Example Process Flows

FIGS. 7A and 7B illustrate process flows used by transmitting and receiving nodes to transmit and receive secured encoded message, in accordance with one or more embodiments of the present disclosure. With reference to FIGS. 7A and 7B, the process flows may comprise a method executed by and/or otherwise associated with any suitable number and/or type of components such as one or more processors (processing circuitry), hardware components, executed instructions (e.g., software components) or combinations of these. The components may be associated with one or more components of the node 200 as discussed herein. The flows 700, 750 may include alternate or additional blocks that are not shown in FIGS. 7A and 7B for purposes of brevity, and may be performed in a different order than shown. Moreover, some blocks may be optional.

Specifically, FIG. 7A provides additional detail regarding the process implemented by a transmitting node upon generating and transmitting a secured message. FIG. 7B provides additional detail regarding the process implemented by a receiving node to validate key counter values in a received secured message to accept or reject the secured message.

Referring first to FIG. 7A, the process flow 700 may be implemented via any one of the nodes discussed herein, such as any of the nodes included in the system 300 for example, when performing a secured message transmission. This may include, for example, the node 200 as discussed herein with respect to FIG. 2A.

The process flow 700 begins with the transmission (block 702) of a secured message. The secured message may be formatted in accordance with any suitable communication protocol and include any suitable number of fields, such as the communication frames as discussed herein with respect to FIGS. 4A-4B.

Upon transmitting the secured message, the process flow 700 includes incrementing (block 704) the freshness value via the transmitting node. This may include, for example, the processing circuitry 208.2 incrementing the locally stored freshness value (e.g., FV.A, FV.B, FV.C, etc.) based upon the particular secure zone corresponding to the intended recipient node(s), as shown in FIG. 2A. Thus, the freshness value that is incremented in this way may be correlated to one or more session keys for that particular secure zone, as discussed herein.

The process flow 700 further comprises the transmitting node determining (block 706) whether a re-keying condition has been met. These conditions may include any suitable predetermined conditions that, when met, result in the key counter being incremented, as further discussed herein, assuming that a priority flag, if implemented, is not set. Such conditions may comprise, for example, a number of secured messages being transmitted with a respective session key in excess of a predetermined number of messages, the expiration of a predetermined time period, each system boot, receiving a security alert request, etc.

As one illustrative example regarding session key exhaustion, the determination regarding whether the number of transmitted secured with a respective session key has exceeded a predetermined number of messages may include determining (block 706) whether the current (now incremented) freshness value exceeds a predetermined threshold value. This predetermined threshold value may be selected as any suitable value that triggers a re-keying process due to session key exhaustion, as discussed herein. For example, the threshold freshness value may be several million or several billion.

Thus, if a re-keying condition is met (e.g., the incremented freshness value exceeds the predetermined threshold), then the transmitting node executes (block 708) a local re-keying process of the key counter values. Thus, using the secured zone A from above as an example, which is assumed to be used for the current secured message transmission, this may include the session key generator 202 incrementing (block 708) the key counter A.1 and overwriting the NVM 204 with this new updated key counter value (e.g., a key counter A.1+1, not shown). Moreover, when a re-keying event occurs, the transmitting node may reset its locally stored freshness value, which is transmitted in the next secured message, to its predetermined or default value (e.g. 1), which is then incremented for subsequently transmitted messages as noted herein.

The process flow 700 also comprises resetting (block 710) the freshness value for the secured zone back to a default or initial value, which is 0 in this example. Thus, continuing the previous example, the freshness value FV.A would be reset to 0 (or other suitable initial value).

The process flow 700 further comprises generating (block 712) an updated session key from the incremented key counter value. This may comprise, using the secured zone A as an example, the session key generator 202 computing the session key A.2 from the shared key A and incremented key counter value in accordance with the KDF, as shown in FIG. 2B. The previous session key A.1 as shown in FIG. 2A may then be overwritten with the updated session key A.2 or otherwise invalidated for future secured transmissions. For example, the updated session key A.2 may be stored in the volatile memory 206 in a new location or overwriting the contents of session key A.1.

The process flow 700 may comprise generating (block 714) a secured message. This may include, for example, the processing circuitry 208.2 generating a secured message as discussed herein having any suitable number of fields. The secured message may be generated in this manner using either the original session key (e.g., session key A.1) if the freshness value was determined (block 706) to be less than the threshold value or, alternatively, the updated session key (e.g. session key A.2) may be used when the freshness value was determined (block 706) to be greater than the threshold value, and thus the key counter and session key were updated. In any event, the secured message may be generated using the current session key to encrypt the payload of the secured message, to transmit the secured message as an authentication only message, or to transmit the secured message as both an authentication and encrypted message. Again, the session key may be one of several (e.g. one being used for authentication and another being used for encryption). In such a case, the process flow may 700 may be extended to selectively update any suitable number of session keys corresponding to the same freshness value.

The process flow 700 may comprise queuing (block 716) the generated secured message. This may include, for example, the communication circuitry 208.1 adding the secured message to a queuing buffer for transmission (block 702) in the appropriate order based upon a messaging priority. Alternatively, if a hardware-based solution is implemented as discussed above with respect to FIG. 5, then the use of a queuing buffer may not be needed, and the secured message may be transmitted (block 702) upon being generated (block 714). The process flow 700 may thus be repeated for each secured message transmission via a transmitting node, with the process flow 700 applying to each subsequent secured message transmission.

Referring now to FIG. 7B, the process flow 750 may be implemented via any one of the nodes discussed herein, such as any of the nodes included in the system 300 for example, when receiving a secured message transmission. This may include, for example, the node 200 as discussed herein with respect to FIG. 2A, when functioning as a receiving node.

The process flow 750 begins with receiving (block 752) a secured message. Again, the secured message may be formatted in accordance with any suitable communication protocol and include any suitable number of fields, such as the communication frames as discussed herein with respect to FIGS. 4A-4B.

The process flow 750 further comprises determining (block 754) whether the message counter, e.g. the key counter value represented by the CNT 406 as discussed herein, is less than the locally stored key counter value corresponding to the secured zone to which the secured message was sent and received. This determination may comprise, for example, comparing the representation of the key counter value encoded by the CNT 406 with the locally stored key counter value for the same secured zone. For instance, the CNT 406 may represent a predetermined number of least significant bits of the key counter value used to generate the encoded message by the transmitting node prior to being received. In such a case, then the determination (block 754) may comprise a comparison via the processing circuitry 208.2 between the same corresponding predetermined number of least significant bits of the locally stored key counter value for the current secure zone. Alternatively, if the entire key counter value is represented by the CNT 406, then the determination (block 754) may comprise a comparison via the processing circuitry 208.2 between the entire locally stored key counter value and the entire key counter value represented by CNT 406 for the current secure zone.

In any event, if it is determined that the key counter value derived from the CNT 406 is less than the locally stored key counter value for that secure zone, then the process flow 750 comprises conditionally approving or rejecting the derived key counter value. For example, the process flow 750 comprises a further determination of whether (block 755) the key counter value derived from the CNT 406 is within the predetermined grace period, as noted above. Again, this grace period may represent a time period that has elapsed since the last, different key counter value was received, and may additionally or alternatively be computed based upon the based upon the freshness values associated with the key counter value derived from the CNT 406.

If the key counter value derived from the CNT 406 is outside of this grace period, then the process flow comprises rejecting (block 756) the secured message. That is, in such a case, the receiving node determines that the key counter value represented by the CNT 406 is invalid, and thus rejects the secured message, as this is indicative of a replay attack, a stale message, or a corrupted message.

In the event that the key counter value derived from the CNT 406 is within the grace period (block 755, Y) or the key counter value derived from the CNT 406 is not less than the locally stored key counter value for that secure zone (block 754, N), the process flow 750 continues and comprises another determination (block 758) regarding whether the opposite condition is true, i.e. the key counter value derived from the CNT 406 is greater than the locally stored key counter value for that secure zone. If this is not the case, then this means that the key counter value derived from the CNT 406 matches the locally stored key counter value for that secure zone, and the process flow 750 proceeds accordingly.

However, in the event that the value derived from the CNT 406 is greater than the locally stored key counter value for that secure zone, then the locally stored key counter value is out of date, as noted above. As a result, the leftmost branch of the process flow 750 corresponds to a conditional local (i.e., at the receiving node) re-keying process. That is, the receiving node may update its locally stored key counter value in such a case only when the key counter value that is represented in the CNT 406 is determined to be valid via an additional message verification process.

For example, upon the receiving node determining (block 758, Y) that the locally stored key counter value is out of date, the process flow 750 comprises generating (block 760) a temporary session key. To do so, the receiving node uses the full length key counter value that was used by the transmitting node to generate the secured message that has been received. Thus, in the event that the CNT 406 represents a truncated portion of the full length key counter value used by the transmitting node to generate the secured message, the receiving node may derive the full length of the key counter value via a computational process. For instance, the receiving node (e.g., the processing circuitry 208.2) may concatenate the non-truncated portion (e.g., the upper significant bits) of the locally stored key counter value with the remaining truncated portion of the full length of the key counter value (e.g. the lower significant bits) represented by the CNT 406.

Once the full length of the key counter value is derived from the CNT 406, the process of generating (block 760) the temporary session key is identical to that used to generate the locally stored session key by both the receiving node and the transmitting node. Thus, the receiving node uses the same KDF and other inputs that were (or should have been) used by the transmitting node to generate the temporary session key. Specifically, the full key counter value is used as one of the inputs to the KDF together with the receiving node's locally stored shared key that corresponds to the current secure zone.

In this way, the full length of the key counter value computed in this manner may be validated by using the temporary session key to decrypt the payload of the secured message, compute the ICV value, and then compare the computed ICV value with the ICV 412 contained in the secure message. Thus, the TCVs will only match (block 762, Y) when the key counter value used to generate the secured message is valid. If not (block 762, N), then the process flow 750 comprises the receiving node rejecting (block 756) the secured message.

Therefore, when the ICVs match one another, the receiving node stores (block 764) an updated key counter value in the NVM 204, overwriting the current key counter value such that the locally stored key counter value now matches the valid, full length the key counter value that was derived from the CNT 406. Again, this key counter value was used by the transmitting node to generate the session key and, in turn, used to generate the current secured message. For example, if the receiving node previously stored the key counter A.1 as shown in FIG. 2A, then after this process the receiving node and the transmitting node would both store the key counter A.1+1.

Additionally, the process flow 750 comprises storing (block 766) the temporary session key that was generated (block 760) from the full length key counter value derived from the CNT 406 as described above as the receiving node's updated local session key. For example, if the receiving node previously stored the session key A.1 as shown in FIG. 2A, then after this process the receiving node and the transmitting node would both store the session key A.2, which is generated using the key counter A.1+1, as shown in FIG. 2B.

The process flow 750 further comprises updating (block 768) the local freshness value to match that received in the secure message. For example, if the receiving node previously stored the freshness value FV.A as shown in FIG. 2A, then after this process the receiving node and the transmitting node would both store the freshness value FV.A+1. Additionally, the receiving node may update the received FV log 206.1 as shown in FIG. 2C to store the FV from the secured message A.2 correlated with the key counter value and secure zone, as noted above.

The process flow 750 further comprises accepting the secured message as the final step in the process, as the key counter value has been validated and the freshness value updated as a result of the local re-keying process.

As noted above, when the receiving node determines (block 758, N) that the key counter value derived from the CNT 406 matches the locally stored key counter value for that secure zone, then the process flow 750 proceeds accordingly. This includes the validation of the key counter value derived from the CNT 406 based upon a comparison of ICVs. Specifically, the receiving node may generate the session key from the key counter value derived from the CNT 406 or, alternatively, use the locally stored session key to decrypt the payload contents, compute the ICV, and then determine (block 770) whether the ICVs match one another. Again, if not, then the secured message is rejected.

Otherwise, the process flow continues to determine (block 772) whether the freshness value contained in the secured message is greater than the locally stored freshness value for the transmitting node and the secure zone, e.g. as shown in the log of FVs in FIG. 2C. If so, then the receiving node rejects the secured message. If not, then the process flow includes updating (block 768) the locally stored FV with the FV contained in the secured message, as discussed above, and accepting (block 776) the secured message. The process flow 750 may thus be repeated for each secured message that is received via a receiving node, with the process flow 750 applying to each subsequent secured message that is received.

### II. Secure Communications Leveraging Protocol Translation

Again, Ethernet Everywhere architecture implementations have drawbacks, particularly with respect to their high costs, although there have been continuing efforts to make 10BASE-T1S (10 Mbit/sec multidrop bus Ethernet) more cost effective. However, such industry efforts are projected to take considerable time, and therefore the embodiments described in this Section focus on the use of an existing bus system (e.g. CAN bus) in the meantime to manage the transition to Ethernet Everywhere solutions.

For example, the various nodes as discussed in Sections I and II, which may include the nodes 200, 800 operating as a transmitting or a receiving node for instance, may form part of an in-vehicle network (IVN) and thus comprise IVN endpoints, together with any other suitable number and/or type of IVN endpoints that make up an in-vehicle secure communication system. In a conventional “Ethernet Everywhere” implementation, such IVN endpoints may interface with one another using Ethernet communication protocols such as 10BASE-T1S, for example, which uses the MACsec standard for security.

Thus, it is noted that MACsec represents the “data plane” security for Ethernet, and uses strong AES-GCM encryption for authentication and (optionally) encryption. Additionally, the current Ethernet standard MKA (MACsec Key Agreement) protocol is conventionally leveraged as one of the “control plane” solutions for MACsec. Thus, MKA represents the IT industry solution for setting temporary “session” keys, but is not suitable for real-time control systems with many endpoints (e.g. a multidrop system), as noted above in Section I. Therefore, the embodiments as described in Section I are directed to an alternative control plane security solution that is well-suited to the demands of real-time control systems. The alternative control plane security solution as discussed in Section I above may be referred to herein as in line key agreement (IKA) security, which leverage a key derivation function (KDF) to derive a key from a counter. This counter value is then stored in a memory and changed by consensus, as discussed in detail in Section I above.

The IKA control plane solutions as discussed in Section I above may leverage various portions of the Ethernet-based MACsec protocol while eliminating the need for dedicated key agreement messages to be exchanged via a central key server. The embodiments as discussed in further detail in this Section may optionally extend this concept to enable existing in-vehicle CAN bus networks and protocols (e.g. CAN bus FD, CAN bus XL, etc.) to leverage the IKA control plane security as discussed in further detail in Section I.

However, although examples are provided in this Section that leverage the IKA control place security solutions as discussed in Section I above in conjunction with MACsec security protocols, these are provided by way of example and not limitation. Additionally, although examples are described throughout this Section with respect to protocol translation mapping between Ethernet and CAN bus protocols, this is also by way of example and not limitation. Thus, it is noted that the embodiments described in this Section may be implemented independently of or combined with those described in Section I to provide protocol translation between any suitable number and/or type of communication protocols. This may include, for instance, mapping parameters between any two suitable communication protocols with or without the use of security-based schemes (e.g. authentication and/or encryption) that may be defined with a communication protocol such as MACsec for instance, with or without the use of the IKA messaging embodiments as described in Section I, etc.

In any event, the embodiments presented in this Section ensure that existing architectures (e.g. CAN bus architectures) may be used to match the security level provided by other communication protocols (e.g. Ethernet-based protocols optionally leveraging MACsec) without requiring the use of an Ethernet network that is used for typical Ethernet Everywhere solutions.

The embodiments as described in this Section may be implemented via software, hardware, or combinations of these. For example, the embodiments as described in this Section may be implemented via one of the nodes 200, 800 as discussed herein, which may implement the various embodiments while transmitting and/or receiving data from another node or suitable data source, and which may be part of an in-vehicle network or other suitable network. To provide an illustrative example, the node 800 as discussed herein may form part of an existing in-vehicle network, and may be configured to provide any of the functionality as discussed in this Section, as further discussed below. Additionally or alternatively, the node 200 as discussed in Section I may be reprogrammed such that the contents of the program memory 208.3 is updated to operate in a manner that combines any of the protocol-translation functionality as discussed in this Section with the IKA messaging embodiments as discussed in Section I.

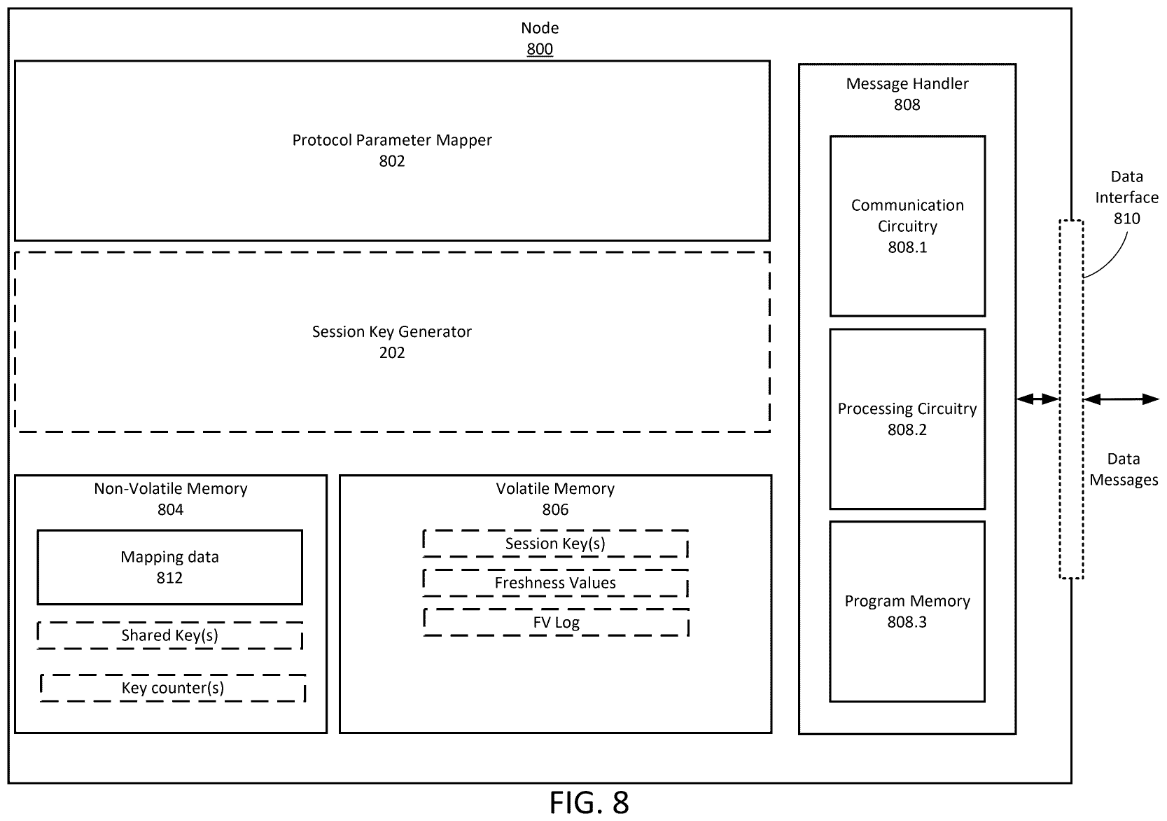

FIG. 8 illustrates another example node architecture, in accordance with one or more embodiments of the disclosure. The node 800 may include similar components as the node 200 as shown in FIG. 2A, and may optionally include the session key generator 202 and store the contents of the non-volatile memory 204 and/or the volatile memory 206, in the non-volatile memory 804 and/or the volatile memory 806, as shown in FIG. 8. Thus, any of the statements of the node 200 as described in Section I are likewise applicable to the node 800 as described in this Section, with differences in their operation, configuration, and/or components being discussed in further detail below. That is, the node 800 may operate independently of the functionality described above with respect to node 200, or may alternatively incorporate any combination of the embodiments as discussed Section I with respect to the node 200.

The node 800 may also be identified with any suitable type of component, and may represent one node in a system of interconnected nodes, such as any of the nodes N₁-N_{X} as discussed in FIG. 3, for example, although the use of the respective connectivity associations as shown in FIG. 3 is optional. The node 800 may be identified with part of an electronic control unit (ECU), a sensor, an actuator, a host, etc., and the various nodes with such an interconnected system may differ in type and/or function, although each node may have a common functionality. Thus, each node in the system of interconnected nodes may be configured to transmit and/or receive messages in accordance with any suitable communication protocol, as discussed further detail herein.

Again, the node 800 may represent one node in an interconnected network of nodes. This may comprise a system of interconnected nodes configured to communicate over a bus according to a multi-drop scheme, as discussed herein. Such a multi-drop scheme may, for example, be part of an in-vehicle E/E architecture as discussed above, which may include a CAN bus architecture, an Ethernet architecture, or other suitable in-vehicle E/E architecture. The node 800 may thus receive, decode, generate, encode, and/or transmit messages (which may comprise message frames that are optionally secured) in accordance with any suitable number and/or type of communication protocols. Thus, the node 800 may transmit and/or receive message frames such as, for instance, a CAN communication protocol frame, a CAN FD communication protocol frame, a CAN XL communication protocol frame, an Ethernet (e.g., multi-drop Ethernet such as 10BASE-T1S, 10BASE-T1L) communication protocol frame, a FlexRay communication protocol frame, a local interconnect network (LIN) communication frame, etc. Thus, the node 800 may transmit and/or receive messages as discussed herein to communicate with other nodes within the system of interconnected nodes using any suitable number and/or type of communication protocols and accompanying modes of operation.

Again, the node 800 may be part of a group of interconnected nodes, which may represent the entirety of the interconnected system of nodes or a subset (e.g. group) thereof. In any event, the node 800 (as well as every other node configured to do so on the bus) is configured to transmit messages to other nodes, and to receive messages transmitted by other nodes, via the data interface 810. Thus, although each node in a communicating group (which includes the node 800) is configured to perform both transmitting and receiving functions, the term “transmitting node” is used herein when referring to any node that is currently performing the transmission of a message and/or performing any functions related to such message transmissions. The term “receiving node” is used herein when referring to any node that is currently receiving a message and/or performing any functions related to such message receptions.

A group of nodes may support the communication of messages in accordance with any suitable type of control system, such as a real-time control system that may be implemented in a vehicle for example. Thus, the node 800 may be one of any suitable number of nodes in a group that communicate with one another via an interconnected network by transmitting and receiving messages via the data interface 810, and which may be coupled to and/or form part of a network, bus, etc., that is used as part of any suitable type of point-to-point or multi-drop scheme. The data interface 810 may comprise any suitable number and/or type of data interface(s) to facilitate the exchange of messages between the node 800 and any suitable number of other nodes within a communicating group of nodes.

To perform message communications, the node 800 comprises a non-volatile memory 804, a volatile memory 806, a message handler 808, and a protocol parameter mapper 802. These components are illustrated in FIG. 8 as being separate entities, with their corresponding functions being described separately for ease of explanation. However, any of the components of the node 800 may be integrated or otherwise combined with one another. The node 800 may also comprise additional or alternative components as those shown and discussed herein with respect to FIG. 8. The non-volatile memory 804, volatile memory 806, message handler 808, communication circuitry 808.1, processing circuitry 808.2, and program memory 808.3, may be implemented as and/or be configured to function in a similar manner as the analogous components of the node 200, e.g. the non-volatile memory 204, the volatile memory 206, the secure message handler 208, and the communication circuitry 208.1, the processing circuitry 208.2, and the program memory 208.3, respectively, with additional or alternate functionalities of the components of the node 800 being described in further detail in this Section.

The message handler 808 may represent an encoder, a decoder, or a combination of both an encoder and decoder, to facilitate the node 800 operating in accordance with any suitable communication protocols as discussed herein. The message handler 808 may comprise any suitable number and/or type of components, with an example of such components being shown in FIG. 8 by way of example and not limitation. For instance, the message handler 808 may comprise communication circuitry 808.1, which may be coupled to the data interface 810 and thus the accompanying network of the system of interconnected nodes as discussed herein. Thus, the data interface 810 may comprise any suitable implementation of components for this purpose, such as for instance wires, buses, and/or respective terminals, ports, pins, etc. The message hander 808 may be configured to generate, receive, decode, encode, and/or transmit message frames in accordance with the embodiments as discussed in further detail throughout this Section, which may include receiving and/or generating first communication frames in accordance with a first communication protocol, mapping parameters of the first communication protocol to fields of a second communication protocol to generate second communication frames in accordance with a second, different communication protocol, and optionally transmitting the generated second communication frames to the connected bus.

The communication circuitry 808.1 may be configured to enable communications between the node 800 and other nodes within a group of nodes, as further discussed herein, via the data interface 810. To do so, the communication circuitry 808.1 may transmit messages to the data interface 810 and receive messages from the data interface 810 in accordance with any suitable number and/or type of communication protocols, such as those discussed herein. The communication circuitry 808.1 may comprise hardware components, software components, or combinations of these, which are typically associated with components configured to perform data communications. For example, the communication circuitry 808.1 may comprise any suitable number of ports, drivers, transmit and/or receive buffers, switches, etc.

The processing circuitry 808.2 may comprise any suitable number and/or type of dedicated hardware components such as a microcontroller, an application specific integrated circuit (ASIC), a field programmable gate array (FPGA), a system on a chip (SoC), dedicated logic and/or other circuitry, etc. The processing circuitry 808.2 may be implemented as one or more processors and/or cores, which may execute computer-readable instructions stored in the program memory 808.3 to perform any of the functions as discussed in further detail herein throughout this Section.

The program memory 808.3 may comprise any suitable type of non-transitory computer readable medium such as volatile memory, non-volatile memory, or combinations of these. To the extent that the node 800 implements software-based solutions to perform the various functions as discussed throughout this Section, this may be achieved, for instance, via the processor circuitry 808.2 executing instructions stored in the program memory 808.3.

The protocol parameter mapper 802 may represent any suitable combination of dedicated hardware, processors, an application specific integrated circuit (ASIC), etc. Although illustrated in FIG. 8 as a separate component, in various embodiments the protocol parameter mapper 802 may be separate from or integrated as part of the processing circuitry 808.2. Thus, to the extent that the node 800 implements hardware-based solutions to perform the various functions as discussed throughout this Section (e.g. the protocol parameter mapping), this may be achieved, for instance, via the processor circuitry 808.2 and/or the protocol parameter mapper 802 as hardware-based implementations, or additionally or alternatively via the processor circuitry 808.2 executing instructions stored in the program memory 808.3.

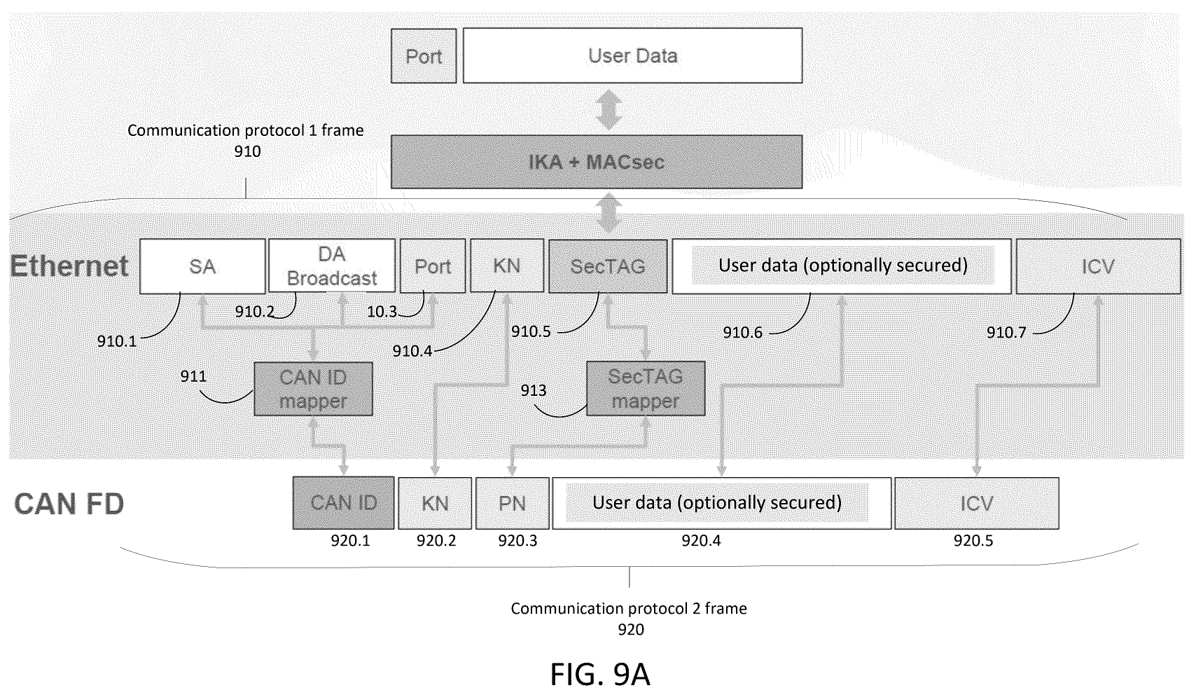

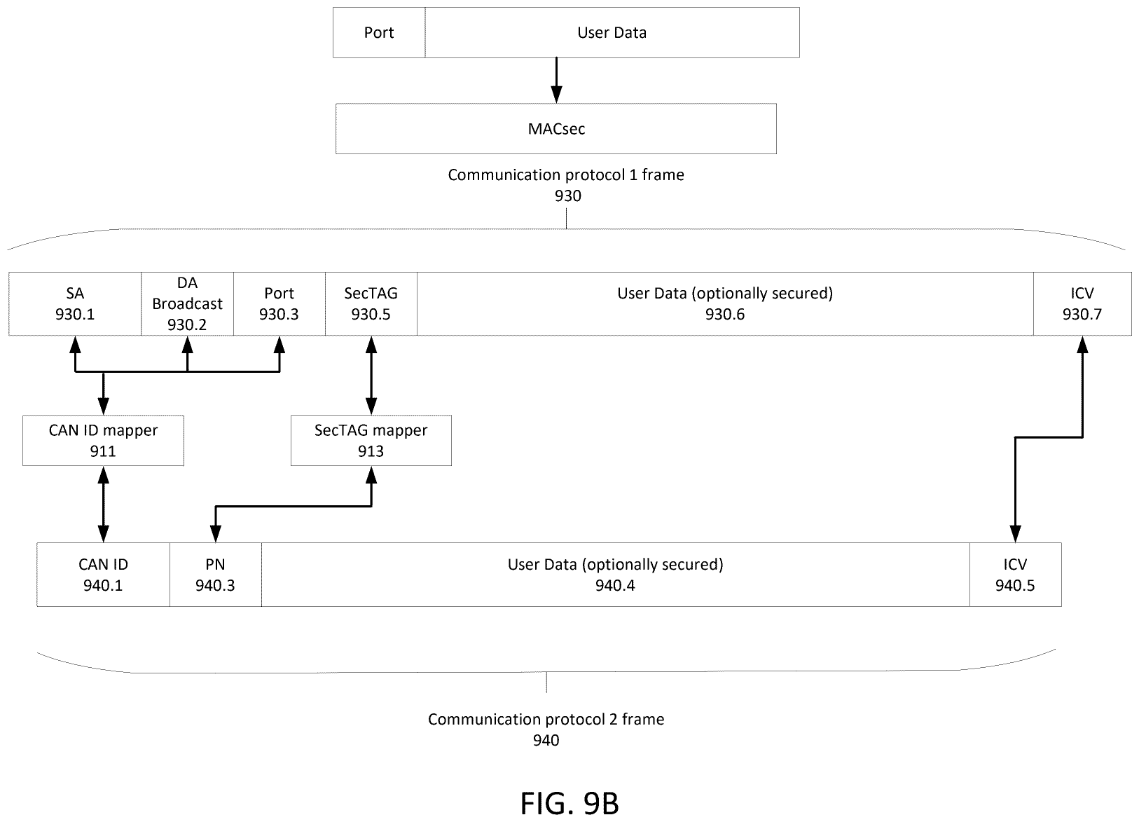

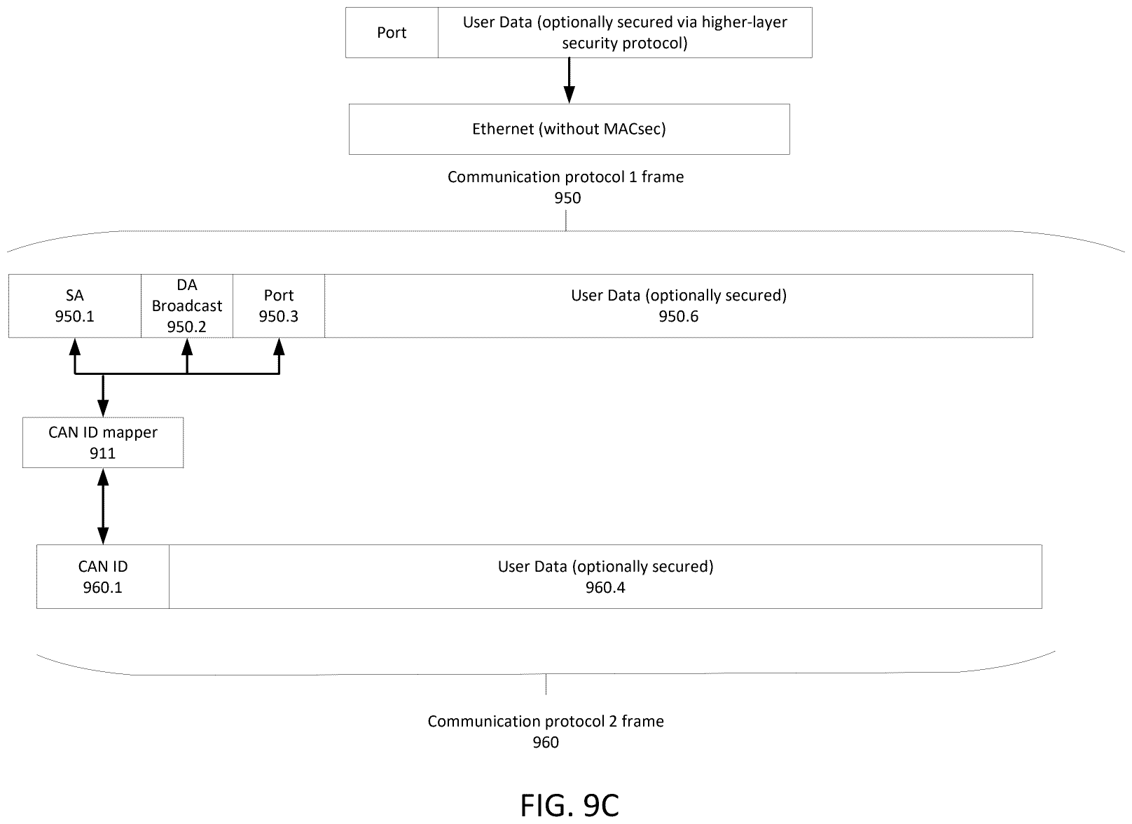

FIGS. 9A-9C illustrate process flows for translating between two different message frame formats, in accordance with one or more embodiments of the present disclosure. That is, each of FIGS. 9A-9C illustrates a protocol translation process that may be used in accordance with the embodiments as further described in this Section. For instance, FIG. 9A illustrates a protocol translation process between an Ethernet frame that is generated in accordance with the embodiments described above in Section I and a CAN frame (and vice-versa). FIG. 9B. illustrates a protocol translation process between an Ethernet frame that is generated in accordance with a conventional Ethernet protocol that utilizes MACsec for security (but without the use of the IKA messages as discussed in Section I) and a CAN frame (and vice-versa). FIG. 9C illustrates a protocol translation process between a conventional, unsecured Ethernet frame (that does not utilize MACsec for security) and a CAN frame (and vice-versa). Again, the use of Ethernet frames, MACsec, and CAN frames as discussed herein are provided by way of example and not limitation, as the embodiments described in this Section may facilitate protocol translation between any suitable types of communication protocols.

To provide an illustrative example, as shown in FIG. 9A, the user data may be initially encoded in accordance with any of the techniques as described in Section I above, which may for instance leverage IKA and MACsec security protocols. This is represented as the “IKA+MACsec” block as shown, which may be performed via the secure message handler 208 for example as discussed in Section I above or, alternatively by the message handler 808 of the node 800, which in this example is assumed to be configured to perform the same functions as the node 200 (and additionally those as discussed in this Section). Thus, the node 800 in this example would also include the optional components equivalent to the session key generator 202 of the node 200 as discussed above (and store the necessary elements in the non-volatile memory 804 and the volatile memory 806), as depicted in FIG. 8 by way of the use of dashed lines.

As noted above for the node 200, the node 800 may likewise be part of an electronic control unit (ECU), and may be configured to operate to receive, generate, encode, decode, transmit, etc., messages (that may optionally be secured messages) among the other nodes within the group of nodes with which the node 800 may communicate via a coupled bus architecture. Thus, the node 800 may be assigned any suitable type of address that allows the node 800 to be identified in accordance with any suitable type of communication protocol that is used to transmit and/or receive messages with other nodes.

Continuing this example, the node 800 may be assigned an Ethernet address, a long-term key (CAK), and a key number (KN) comprising any suitable byte length (e.g. 4 bytes, 6 bytes, etc.). Again, this data may be stored in any suitable portion of the node 800, such as the non-volatile memory 804 for example. Then, a static mapping may be performed between the CAN ID to/from one or more MACsec secure channel indicator (SCI) values. This static mapping may comprise, for example, the mapping data 812 that are also stored in any suitable memory location, such as the non-volatile memory 804, for example, as shown in FIG. 8. The static mapping may comprise, for example, a lookup table (LUT) or any other suitable format that correlates the CAN ID of the node 800 with the one or more MACsec secure channel indicator (SCI) values. The mapping process may include additional or alternate parameters that are translated between Ethernet and CAN ID frames, which may alternatively be referred to as secured messages as noted in Section I.

Thus, the Ethernet frame 910 as shown in FIG. 9A may represent, for example, the communication frames 400, 450, as shown and discussed above with respect to FIGS. 4A and 4B, and may alternatively be referred to throughout this Section as “IKAsec” Ethernet frames to denote the secured nature of such frames using a combination of the IKA and MACsec operations as discussed in Section I. The IKAsec Ethernet frame 910 as shown in FIG. 9A may, for example, comprise a short Ethernet frame and comply with any suitable Ethernet protocol such as 10BASE-T1S, 10BASE-T1L, etc. Thus, although referred to herein in terms of Ethernet and CAN frames, this is by way of example and not limitation, and the parameter mapping functionality as discussed herein may be implemented between any two suitable communication protocols to optionally leverage the use of security protocols defined by one communication protocol while transmitting and receiving communication frames in accordance with another protocol. Again, each respective communication protocol defines a communication frame in accordance with predetermined fields and parameters. For instance, and as discussed above, one such protocol may comprise a CAN communication protocol, a CAN FD communication protocol, a CAN XL communication protocol, a FlexRay communication protocol, a local interconnect network (LIN) communication protocol, etc. The other communication protocol that is used for mapping to and from such communication protocol frames may include, for instance, an Ethernet communication protocol, which may include for instance multi-drop Ethernet such as 10BASE-T1S, 10BASE-T1L, or any other suitable Ethernet-based communication protocol, which may include point-to-point and/or multi-drop Ethernet protocols.

However, for the embodiments as described in this Section, the message handler 808 (or other suitable components of the node 800, a bridge, etc.) may additionally translate the IKAsec Ethernet frame as shown in FIG. 9A into a CAN frame, such as the CAN FD frame 920 as shown in FIG. 9A for example. That is, a short Ethernet frame to be transmitted is first generated, and then translated into the CAN frame 920 as shown in FIG. 9A. Additionally, the node 800 may perform this process in reverse when receiving CAN frames 920, which may be formatted to include information that may then be mapped to the various fields of an IKAsec Ethernet frame 910. The message handler 808 may thus translate the CAN frame 920 to the IKAsec Ethernet frame 910 for software processing, thereby ensuring that the Ethernet-based MAC security protocols are leveraged despite receiving the data as a CAN frame 920. For instance, when receiving a CAN frame 920, it is noted that the ICV and the encrypted user data is already in MACsec format, so the translation from the CAN frame 920 to the IKAsec Ethernet frame 910 comprises a mapping of these fields as shown in FIG. 9A. This is also the case for the key number (KN) fields 910.4, 920.2 as shown.

In this way, the use of the Ethernet-based security protocols may be transparent to the application executed on the node 800. For instance, the node 800 may transmit and receive CAN frames 920 via a CAN bus network, but translate from the CAN frames 920 to the IKAsec Ethernet frames 910 in software or hardware. As another example, the message handler 808 may transmit and receive Ethernet frames 910 via an Ethernet network, but translate from the Ethernet frames 910 to the CAN frames 920 in software or hardware. In this way, an existing in-vehicle network that is configured to communicate CAN frames via a CAN bus network may leverage Ethernet-based MACsec security by updating the software of the various nodes to perform frame translation, as discussed herein. Additionally, existing CAN FD nodes may be seamlessly integrated into an Ethernet Everywhere network.

As another example, an in-vehicle network may comprise one or more bridges that are configured to convert between Ethernet and CAN frames and/or vice-versa. Such bridges may be configured to perform this frame conversion process using hardware, software, or combinations of these, although hardware-based bridges may be particularly useful due to their speed. Thus, in accordance with implementations using bridges, the node 800 may transmit an IKAsec Ethernet frame 910, as shown in FIG. 9A. The bridge may then convert the IKAsec Ethernet frame 910 to the CAN frame 920 that comprises the contents that map to the transmitted IKAsec Ethernet frame 910, which is then transmitted via a CAN bus network. The transmitted CAN frame 920 may then be transmitted to a CAN node or, alternatively, to another bridge that converts the CAN frame back 920 to an IKAsec Ethernet frame 910 that is received by another node. Of course, the bridges may operate in either direction, and the Ethernet and CAN frames 910, 920 may be translated to one another in either direction based upon the capabilities of the nodes and the in-vehicle network. The use of bridges in this manner is also optional, and all translation processes as discussed herein may be performed via the nodes 800.

Again, the conversion between the CAN frame 920 and the IKAsec Ethernet frame 910 may also comprise the use of various mappers, such as the CAN ID mapper 911 and the SecTAG mapper 913 as shown in FIG. 9A, for example, the functions thereof again being executed as software, hardware, or combinations of these. For instance, the CAN ID mapper 911 and/or the SecTAG mapper 913 may be implemented as part of the protocol parameter mapper 802 and/or via execution of instructions stored in the program memory 808.3 via the processing circuitry 808.2.

The SecTAG mapper 913 is configured to translate between the SecTAG 910.5 of an IKAsec Ethernet frame 910 to a packet number 920.3 of a CAN frame 920, and vice-versa. This may be achieved, for instance, by truncating a predetermined number of bits from the Ethernet frame 910 to generate the CAN frame 920 or, in the opposite direction, by padding the packet number from the CAN FD PN field 920.3 with a predetermined number of bits to fit the SecTAG field 910.5 of the Ethernet frame 910.

The CAN ID mapper 911 is also configured to map one or more parameters from the Ethernet frame 910 to the CAN frame 920, and vice-versa, which may include for example parameters that identify the transmitting node and/or one or more destination nodes in accordance with respective Ethernet and CAN bus protocols. For instance, the CAN ID mapper 911 is configured to map the source address (SA) field 910.1, destination address (DA) broadcast field 910.2, and port ID field 910.3 from the Ethernet frame 910 to the CAN ID field 920.1 of the CAN FD frame 920, and vice-versa (as part of a reverse mapping process). To do so, when transmitting the CAN FD frame 920, the CAN ID mapper 911 may reference a LUT that includes a static mapping of the Ethernet source address and port number to a specific CAN ID. In the opposite direction, i.e. when receiving a CAN frame 920, the CAN ID mapper 911 may use another LUT and a reverse lookup function (e.g. stored as part of the mapping data 812) that receives the CAN ID as input and then outputs the Ethernet source address and port number.

The DA broadcast field 910.2 of the Ethernet frame 910 may be optionally used as part of the CAN ID mapping process. For example, the LUT referenced by the CAN ID mapper 911 may be sectioned into a subset of different groups, with the DA broadcast field 910.2 containing a reference to one or more destination addresses that may reference each of these groups to determine a number of CAN IDs that are included as part of the CAN ID field 920.1. Thus, when the DA broadcast field 910.2 identifies a number of recipients, the CAN ID mapper 911 may translate these to a number of CAN IDs via a set of corresponding LUT functions. The CAN ID field 920.1 may therefore contain more than one CAN ID, with the transmitted CAN frame 920 being processed by receiving nodes that identify these CAN IDs as their own.

The LUT referenced by the CAN ID mapper 911 may be stored in any suitable location of each node 800, such as the mapping data 812 that is stored in the non-volatile memory 804 of the node 800 as shown in FIG. 8 for example. Additionally or alternatively, the mapping data 812 may be stored in the volatile memory 806 of the node 800 or in any other suitable location accessible to the node 800. Thus, the mapping data 812 may be primarily static in nature and constitute a predetermined mapping between the various parameters that are used to identify a node in terms of an Ethernet frame (e.g. port and source address) and the parameters used to identify a node in terms of a CAN frame (e.g. CAN ID). Of course, the mapping data (e.g. LUT(s)) may be updated as needed to reflect updates to the in-vehicle network, the addition or removal of nodes, etc.

Turning now to FIG. 9B, a protocol translation process is shown between an Ethernet frame that is generated in accordance with a conventional Ethernet protocol (e.g. 10BASE-T1S or 10BASE-T1L) that utilizes MACsec for security (but without the use of the IKA messages as discussed in Section I) and a CAN frame. Thus, for the example as shown in FIG. 9B, the node 800 for example may generate the user data as part of communication frame generation process (e.g. via the message handler 808), which may be initially encoded in accordance with a conventional Ethernet communication protocol (e.g. 10BASE-T1S and 10BASE-T1L). Again, this may leverage the MACsec security protocols, as represented by the “MACsec” block as shown.

In this example, and as was the case for the Ethernet frame 910, the node 800 is thus assigned an address that is used to provide the source address (SA) field 930.1 (e.g. an Ethernet address), the destination address broadcast field 930.2, and the port field 930.3. In addition to the (optionally secured) user data in the user data field 930.6, the Ethernet frame 930 also includes data in the SecTAG field 930.5 and the ICV field 930.7, as this data is provided by way of the MACsec security protocol. However, in contrast to the Ethernet frame 910, the Ethernet frame 930 does not include a key number (KN), as this is a function provided by the IKAsec embodiments as discussed in Section I. It is noted that “secured” as used throughout this disclosure with respect to any suitable type of data such as e.g. user data, messages, and/or frames may include the use of any suitable security protocol, which may be defined by and/or used in accordance with a corresponding communication protocol and comprise any suitable cryptographic function, cryptographic protocol, cryptographic hardware, algorithm, etc. to authenticate and optionally encrypt the respective data (e.g. user data, messages, and/or frames, etc.). Thus, the secured messages may comprise authentication only messages, or alternatively, authentication and encryption messages. Thus, the user data may be secured in this manner by using any suitable security protocol (such as MACsec in this example) to provide the user data as authenticated data or, alternatively, as both authenticated and encrypted user data.

Thus, the CAN ID mapper 911 and the SecTAG mapper 913 function in the same manner as described for the Ethernet frame 910, i.e. by mapping the SA field 930.1, the DA broadcast field 930.2, and the port number field 930.3 to the CAN ID field 940.1, and vice-versa. Additionally, the SecTAG mapper 913 operates in the same manner by mapping the SecTAG field 930.5 to the PN field 940.3, and vice-versa. Finally, the ICV field 930.7 is mapped to the ICV field 940.5, as discussed above. However, because the Ethernet frame 930 does not include a key number (KN) field (e.g. the key counter value as discussed in Section I or portions (e.g. truncated portions) thereof), which is not used for conventional MACsec security protocols, the resulting CAN frame 940 does not include a KN field.

Further turning to FIG. 9C, a protocol translation process is shown between a conventional, unsecured Ethernet frame (that does not utilize MACsec for security) and a CAN frame. Thus, for the example as shown in FIG. 9C, the node 800 for example may also generate the user data as part of communication frame generation process (e.g. via the message handler 808), which may be initially encoded in accordance with a conventional Ethernet communication protocol (e.g. 10BASE-T1S and 10BASE-T1L). In this example, MACsec is not used, however, and thus the resulting encoded data is shown in FIG. 9C represented as the “Ethernet (without MACsec)” block as shown.

In this example, and as was the case for the Ethernet frame 910, the node 800 is thus assigned an address that is used to provide the source address (SA) field 950.1 (e.g. an Ethernet address), the destination address broadcast field 950.2, and the port field 950.3. The Ethernet frame 950 also includes (optionally secured user data) in the user data field 952.6. However, the Ethernet frame 950 does not include a include a SecTAG field 950.5 or an ICV field 950.6 because MACsec is not used in this example. Furthermore, the SecTAG mapper 913 is not needed for the example scenario as shown in FIG. 9C, and thus the resulting CAN bus frame 960 does not include a PN field. The CAN ID mapper 911 may otherwise function in the same manner as described for the Ethernet frame 910, i.e. by mapping the SA field 950.1, the DA broadcast field 950.2, and the port number field 950.3 to the CAN ID field 960.1, and vice-versa.

And, as was the case for the translation processes as described herein, such as those shown in FIGS. 9A and 9B, for instance, when receiving the CAN frame 970, the node 800 may process the CAN frame by first translating it to the Ethernet frame 950 via the reverse-mapping process as discussed herein. The node 800 may then process the Ethernet frame 950 in accordance with the same communication protocol that was used to generate the Ethernet frame 950 (e.g. 10BASE-T1L, 10-BASE-T1S, etc.). In this way, the node 800 may process the content of the CAN frame 970 (i.e. the received message, which is unsecured in the example), in accordance with an Ethernet protocol (in this example) by way of the mapping of the fields of the CAN frame 970 to the Ethernet frame 950. Of course, this may be applied to additional or alternate security protocols and/or communication protocols, and may likewise be performed in a similar manner for secured messaging embodiments such as those shown in FIGS. 9A and 9B for instance. Again, the node 800, in such secured messaging cases, may only authenticate the received message or perform an authentication and decryption of message content (e.g. the user data) for received secured messages based upon which option was used by the transmitting node. The reweaving node 800 may do so using a security protocol and/or communication protocol that is identified with that used to generate the received secured message (e.g. MACsec, a higher-layer security protocol as discussed below, etc.) by the transmitting node.

Additionally or alternatively, the protocol translation processes as described in this Section may implement any suitable number and/or type of higher-layer security protocols (e.g. with respect to the Ethernet layer) to provide the secured messages that are transmitted or received by a node. For instance, and as discussed with respect to FIG. 9B, the user data may be optionally secured via MACsec, which is then mapped to field 960.4 of the communication frame 940 (e.g. a CAN frame).

However, and with continued reference to FIG. 9C, the initial communication frame (e.g. including the port number and user data as shown in FIG. 9C) may contain user data or other suitable data that is secured via a higher layer or alternate layer than the Ethernet layer (e.g. other than MACsec), which is represented as the Ethernet block as shown in FIG. 9C. Thus, in accordance with such embodiments, the frame 950 may be secured by another high-layer security protocol but not secured by MACsec. Examples of such alternate and/or higher-layer security protocols that may be used for this purpose include Internet Protocol Security (IPsec), Transport Layer Security (TLS), Advanced Automotive Solutions Security On-board Communication (AUTOSAR SecOC), etc. Data that is secured in this manner may then be authenticated and optionally decrypted by a receiving node by using a reverse-mapping process as described herein and then recovering the secured user data in the Ethernet frame 950 using the same higher-level security protocol that is available at the receiving node. In this way, the embodiments described herein may provide the flexibility to implement additional security protocols within an E/E architecture.

### A. Secure Ethernet API

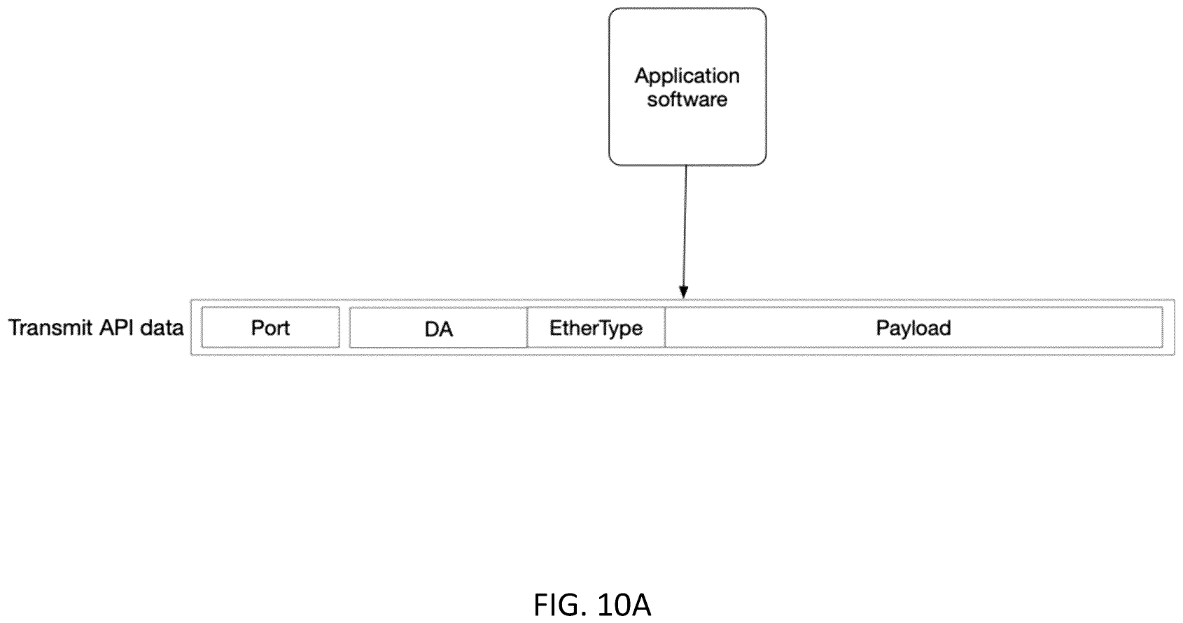

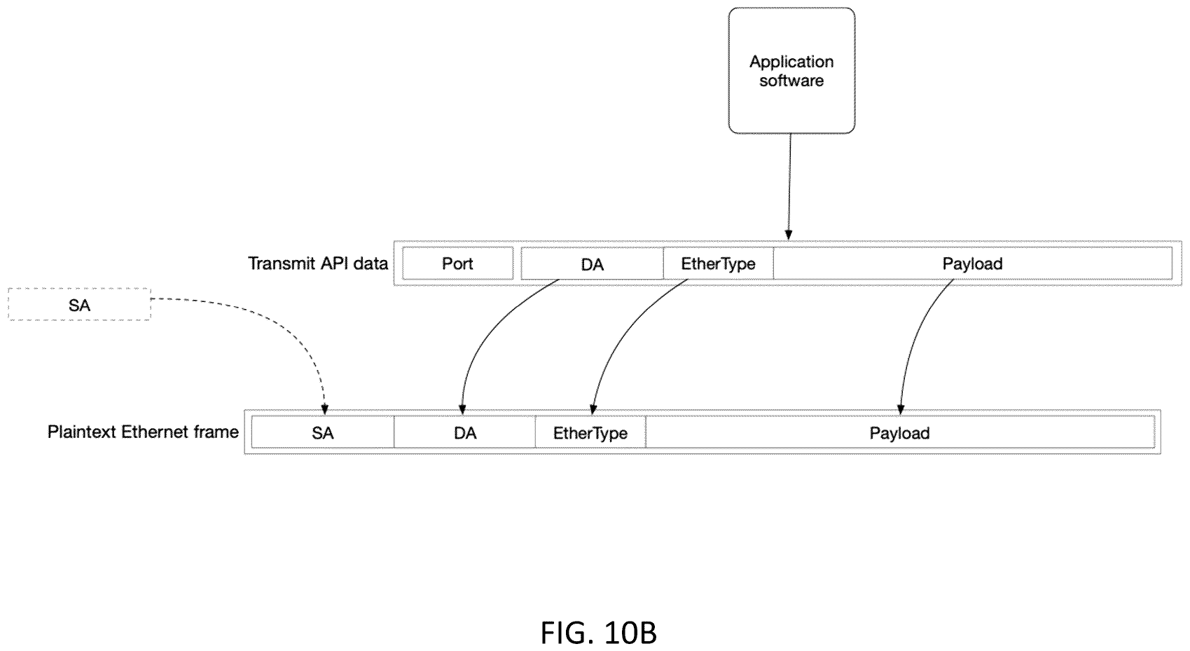

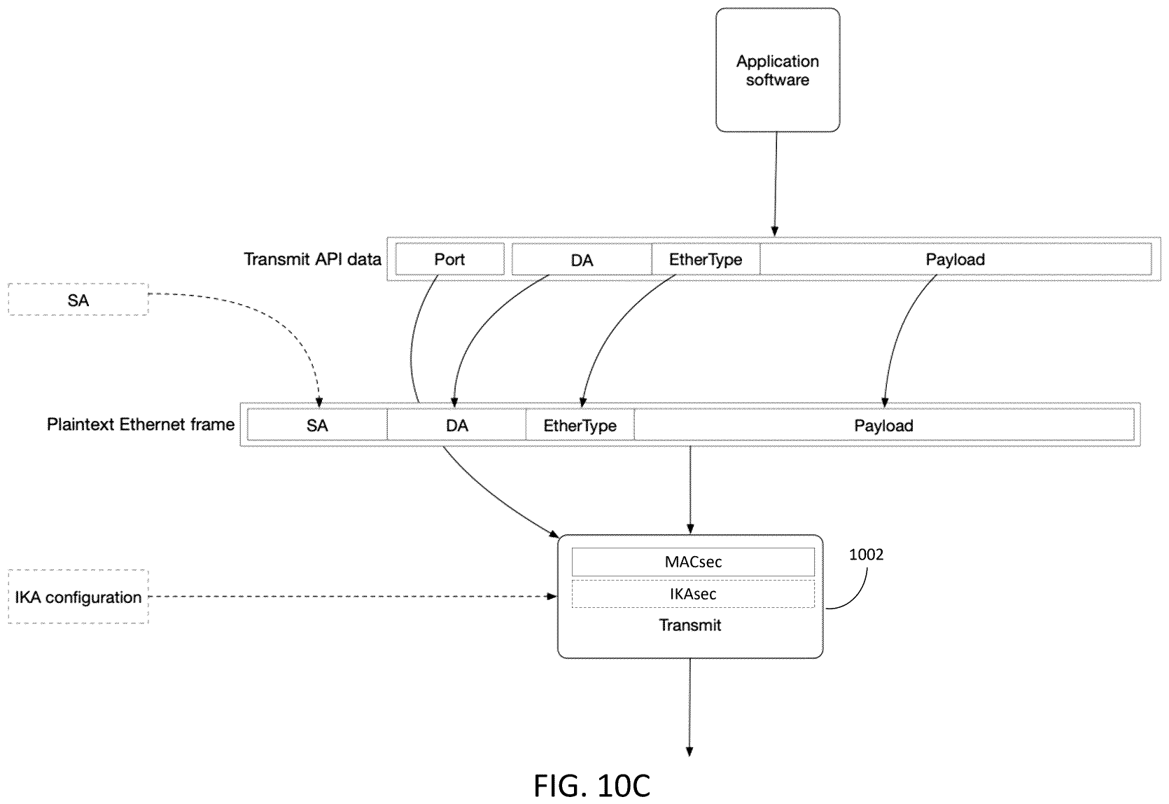

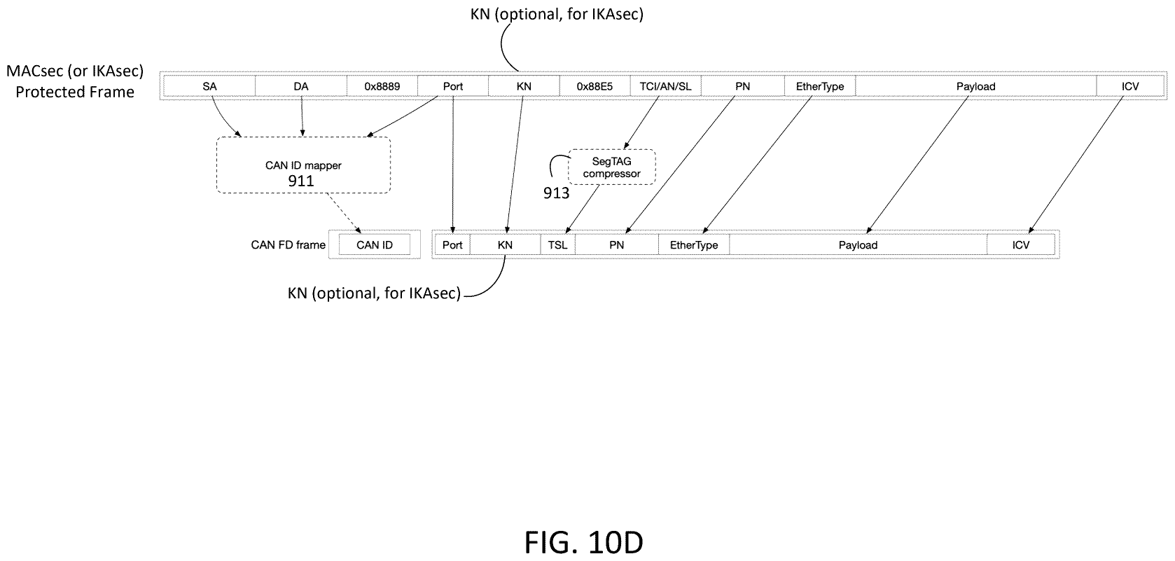

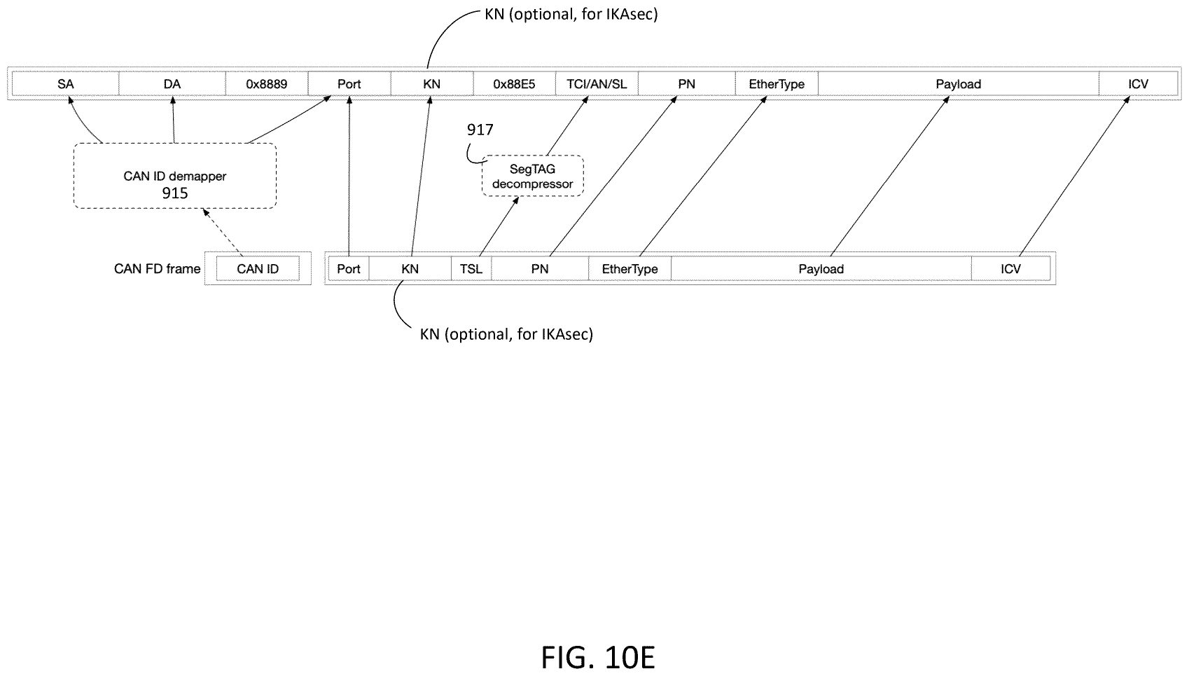

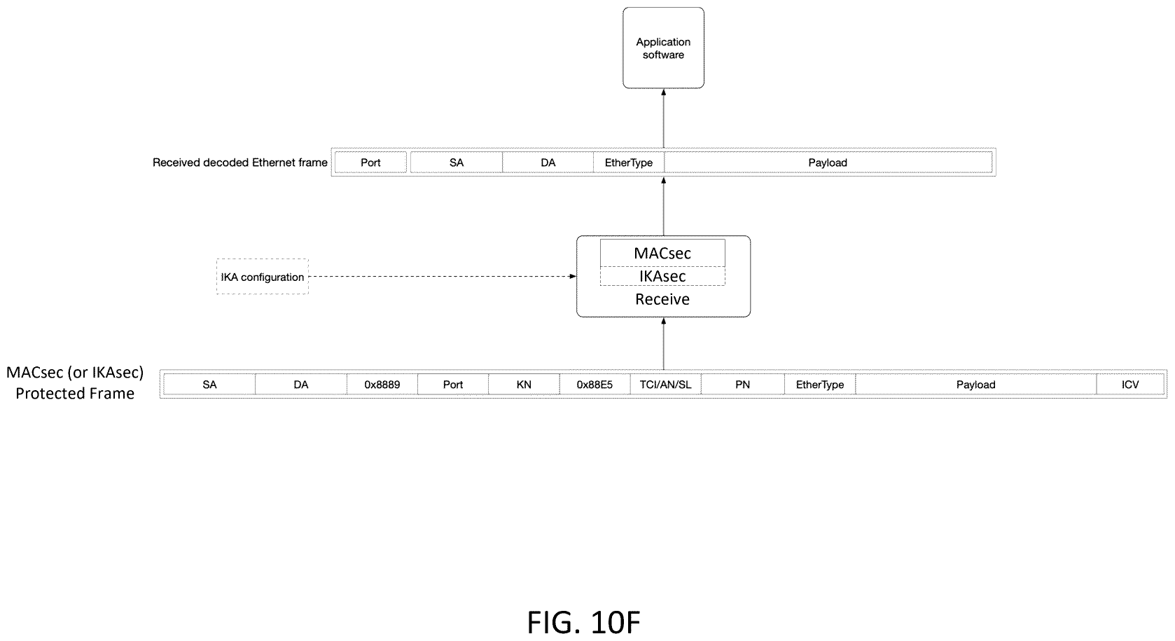

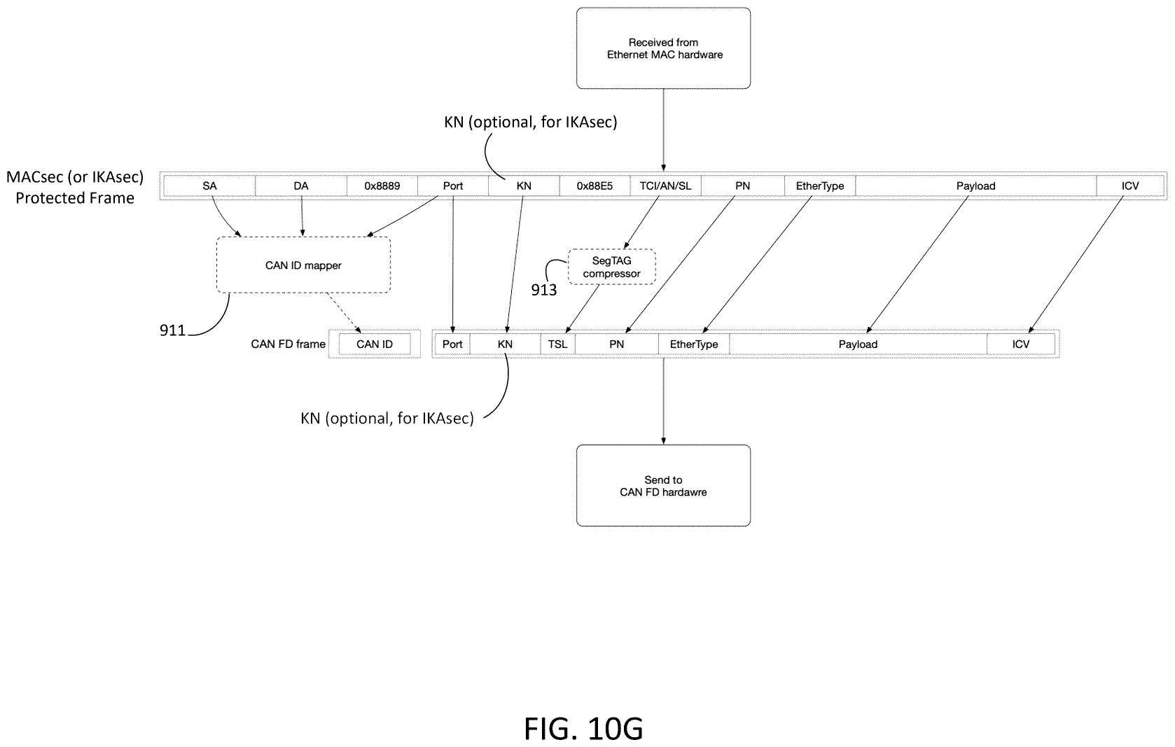

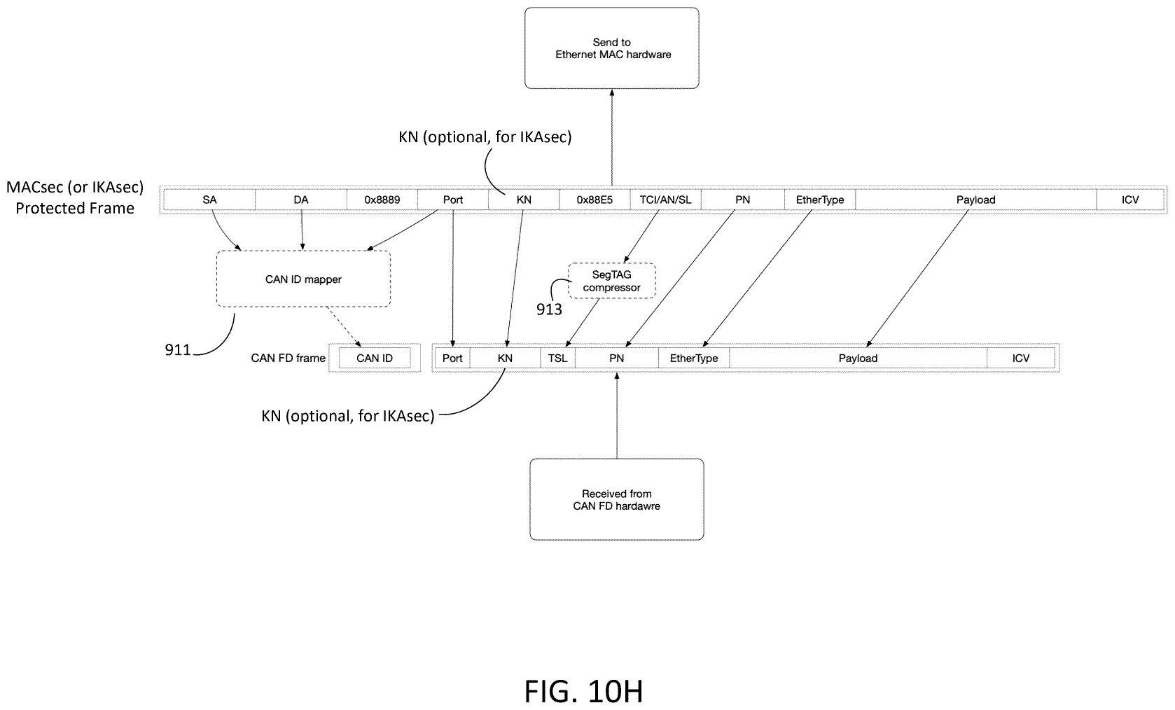

FIGS. 10A-10H illustrate additional details regarding process flows for translating between two different secured message frame formats, in accordance with one or more embodiments of the present disclosure. FIGS. 10A-10H show examples of a secure Ethernet API operation. The operations as shown and discussed with respect to such secure Ethernet API operations may be performed by any suitable device as discussed herein. For instance, the embodiments as discussed in this Section may be implemented by the node 800 executing instructions stored in the program memory 808.3, executed via hardware components (e.g. the processing circuitry 808.2), a bridge device, or combinations of these. It is also noted that FIGS. 10A-10H provide examples of secured messages being generated using the MACsec or IKAsec Ethernet protocols, although this is by way of example and not limitation. As discussed above, the embodiments of protocol translation and parameter mapping may be applied to both secured and unsecured frames. Thus, the statements provided below are by way of example, and may be applied to protocol translation for unsecure messages by omitting the configuration and parameters with respect to the secure messaging protocols, such as by including only those mapping processes as discussed above with respect to FIG. 9C, for instance.

As shown in FIG. 10A, an application that is to communicate securely generates Ethernet data. The “application software” in the examples provided with respect to FIGS. 10A-10H may comprise, for instance, the execution of the program memory 808.3 via the processing circuitry 808.2, as discussed herein. The Ethernet data may include various parameters such as, for example, a destination address (DA), an EtherType (2-byte field), and payload data. Additionally, a port number is provided to allow the Ethernet MACsec cryptographic layer to protect the frame. This data is then used, along with device configuration (the source address of the device) to generate a plaintext Ethernet frame as shown in FIG. 10B.

With continued reference to FIG. 10B, the dashed box shows a configuration value (in this case, the address of this sending device). The plaintext Ethernet frame may be sent directly to the Ethernet hardware to send the frame, but it would be unprotected (i.e. it could be spoofed, tampered with, etc.). Thus, to secure the frame, the MACsec (and optionally the IKA protocols) may be used as discussed in further detail in Section I above. Again, when the IKA protocols are used in combination with MACsec, this may be referred to herein as “IKAsec.” Thus, a node, such as the transmitting node 200/800, for instance, may generate a secured message, which may comprise a protected frame as discussed herein, using the MACsec or, optionally, the IKAsec protocol. An example of this generated protected frame is shown in FIG. 10C. Thus, the output of the block 1002 as shown in FIG. 10C may correspond, for example, to the Ethernet frames 910, 930 as shown in FIGS. 9A and 9B.

As noted in Section I above, IKA and MACsec require configuration information, such as a shared cryptographic key. The use of cryptographic information in this manner is represented in FIG. 10C as the dashed blocks. This frame may be copied directly to the Ethernet hardware to be sent on an Ethernet network, assuming that the transmitting node is configured to transmit Ethernet frames (e.g. via the communication circuitry 808.1) and the in-vehicle network supports such transmissions. However, and as further discussed herein, once generated, this frame may alternatively be transformed into any suitable type of CAN frame, such as a CAN FD frame 920, 940 for instance, as shown in FIGS. 9A and 9B. Additional details regarding the “Ethernetification” of the CAN FD frame to ensure compatibility between interconnected nodes is discussed in further detail below.

### B. Ethernetification of CAN FD

Any suitable information in the secured Ethernet frame (shown as “protected frame” in the FIGS. 10A-10H), such as essential information and/or other suitable information that may be represented as one or more parameters of the secured Ethernet frame, may be used to create an “Ethernet” CAN FD frame as discussed herein and as shown in FIGS. 9A and 9B. As one example, there are generally two parts (also referred to herein as parameters or values, which may be represented as respective fields) to a CAN frame. One is the CAN ID, which may comprise an 11-bit or a 29-bit field for instance (e.g. the CAN ID fields 920.1, 940.1), and the other comprises the payload, which may contain a field of up to 64 bytes for example (e.g. the user data fields 920.4, 940.4). Again, and as shown and discussed above with respect to FIGS. 9A and 9B, the CAN frame may be generated via a CAN ID mapper (e.g. the CAN ID mapper 911) and a SecTAG compressor (also referred to herein as a SecTAG mapper, e.g. the SecTAG mapper 913).

This process is illustrated in further detail in FIG. 10D, which shows the CAN ID mapper 911 and the SecTAG mapper 913 functions utilizing the configuration information associated with the device (e.g. the transmitting or receiving node 800) to generate the corresponding fields of the CAN frame. As one example, the CAN ID mapper 911 uses the source address (SA), destination address (DA), and port fields of an secured Ethernet frame to determine the CAN ID. To do so, the CAN ID mapper 911 may reference, for example, the mapping data 812, as noted above with respect to FIGS. 9A and 9B, which may be generated and stored at system build time. Such a build-time generation may comprise, for instance, those used in accordance with embedded systems (sometimes referred to as “engineered networks”). The contents of the stored table may comprise, for example, a list of CAN IDs transmitted by the node, and each of these CAN IDs may be associated either with a broadcast DA (Ethernet defines any DA with a 1 in the least-significant bit of the first byte as a broadcast address) or a specific destination device. In general, for an in-vehicle network bus, data is broadcast to many receivers.

The port may also be included as a parameter, as there may be multiple transmit secure channels for priorities (typically 4 or 8). Additionally, there may be more port numbers in use at a given device than priorities. A truncated port number from the secured Ethernet frame may thus be mapped to the CAN FD frame, as it is not necessary in an engineered network to support more than 256 transmit secure channels.

The SecTAG mapper 913 may be configured to receive the TCI, AN, and SL fields of the SecTAG from the secured Ethernet frame, and to reduce (e.g. compress) these parameters to a single field comprising a lesser number of total bits, such as 8 bits for instance. As the SL field needs to encode values up to 48, 6 bits of the 1-byte TSL field in the CAN FD frame are sufficient in this example. Additionally, only one bit in the TSL field is necessary to encode the E and C fields of the TCI (i.e. whether the frame is encrypted or authenticated only). The PN, payload, and ICV fields may be directly mapped to the corresponding fields of the CAN FD frame. Again, once the transmitting node transmits the CAN FD frame in this manner, a receiving node may then decompress the CAN FD to generate the secured Ethernet frame as discussed herein, which may then be further processed to authenticate and/or decrypt content of the secured message. Again, once the secured Ethernet frame is generated in this manner, the authentication and/or decryption process may be based upon the cryptographic function defined in accordance with the Ethernet communication protocol (e.g. as defined by the MACsec security protocols).

To do so, it is noted that the decompression of a CAN FD frame at a receiver operates in reverse, as illustrated in FIG. 10E, which may also be performed for example via the message handler 808, as noted above with respect to the transmission of message frames. The CAN ID demapper 915 and the SecTAG decompressor 917 may be implemented as the same components described herein with respect to the CAN ID mapper 911 and the SecTAG mapper 913, for example. For instance, the CAN ID may be passed through the CAN ID demapper 915 as shown. The CAN ID demapper 915 may be implemented, for instance, as part of the protocol parameter mapper 802 and/or via execution of instructions stored in the program memory 808.3 via the processing circuitry 808.2. This may include, for instance, using a reverse lookup table that functions to map the CAN ID of the CAN FD frame to the SA, DA, and port parameters of the secured Ethernet frame using the mapping data 812. Thus, the node 800 may store any suitable number of tables as part of the mapping data 812, with specific tables being used based upon whether a mapping or demapping function is being performed, as discussed herein. In both cases (i.e. when translating from a secured Ethernet frame to a CAN FD frame, and vice-versa), a mapping process occurs to translate (e.g. “map”) one or more parameters between one type of secured message (e.g. a IKAsec Ethernet frame) and one or more parameters of another type of secured message (e.g. a CAN FD frame) using the contents of the stored tables. And because the tables are static (e.g. created at build time) the tables may be ordered and/or indexed in any suitable manner, such as by CAN ID, for instance, and searched using any suitable type of algorithm, such as an efficient “binary chop” algorithm for instance.

Additionally, the SecTAG decompressor 917 also operates in reverse. For instance, the (e.g. 8-bit) SL field and the TCI, E, and C bits may be set according to the TSL field in the CAN FD frame. The other TCI fields, as well as the AN field, may be assigned fixed values for instance. The PN, EtherType, Payload, and ICV fields may be directly mapped (e.g. copied) into the secured Ethernet frame.

The secured Ethernet frame that is translated in this manner from the CAN FD frame may then be handled as for any other such frame. For instance, and turning now to FIG. 10F, for the application at a receiving node, the Ethernet frames received from a physical Ethernet network are indistinguishable from the translated Ethernet frames received via a CAN FD bus. In other words, the use of the translated communication protocols in this manner is transparent to the application executed on the node 800.

Furthermore, it is noted that a secured Ethernet frame that is translated from a CAN FD frame in this manner may have a limited payload compared to a true Ethernet frame. For instance, Ethernet frames may carry 1500 bytes, but CAN FD frames are limited to just 64 bytes. When used, in conjunction with the Ethernetification overhead for IKA and MACsec, this may potentially reduce application payloads to about 44 bytes. However, it is noted that for in-vehicle real-time embedded control applications, this typically does not present an issue, as the transmission of large data payloads is seldom needed.

### C. CAN FD/Ethernet Bridging

In typical architectures, there may be a need to carry the translated “Ethernet” CAN FD frames to and from pure Ethernet networks. This may be accomplished via a bridge, for example, as noted above. However, unlike in other networking schemes, there is no need for the bridge to participate in MACsec or IKA, as this block and the accompanying processing operations may be performed as a pure frame handler.

An example of an Ethernet-to-CAN FD bridging process is illustrated in FIG. 10G, whereas an example of a CAN FD-to-Ethernet bridging process is illustrated in FIG. 10H. As may be observed by both FIGS. 10G and 10H, no security configuration (such as cryptographic keys) are required to be installed on such a bridge device.

### D. Mixed Traffic on CAN FD

Finally, it is noted that nothing in the Ethernetification of CAN FD frames as discussed throughout this Section prevents ordinary CAN traffic on the same bus and at the same time. This permits legacy devices (such as diagnostics messages) to continue to operate until a transition to full Ethernet.

### E. Example Process Flows

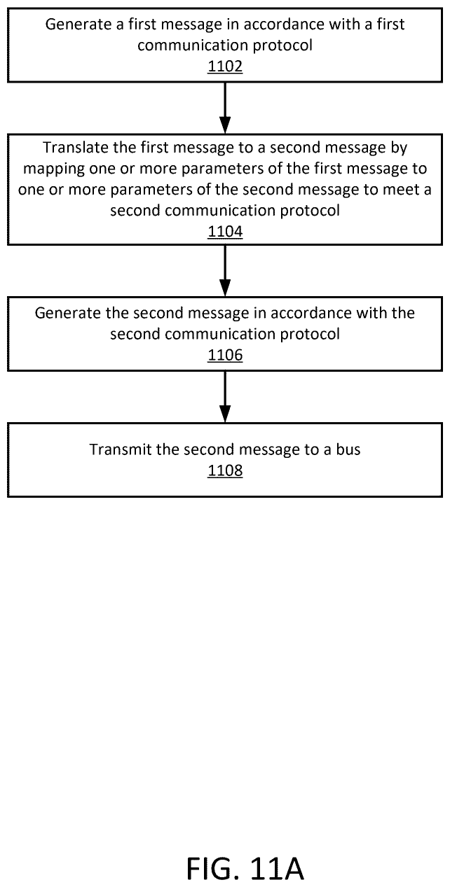

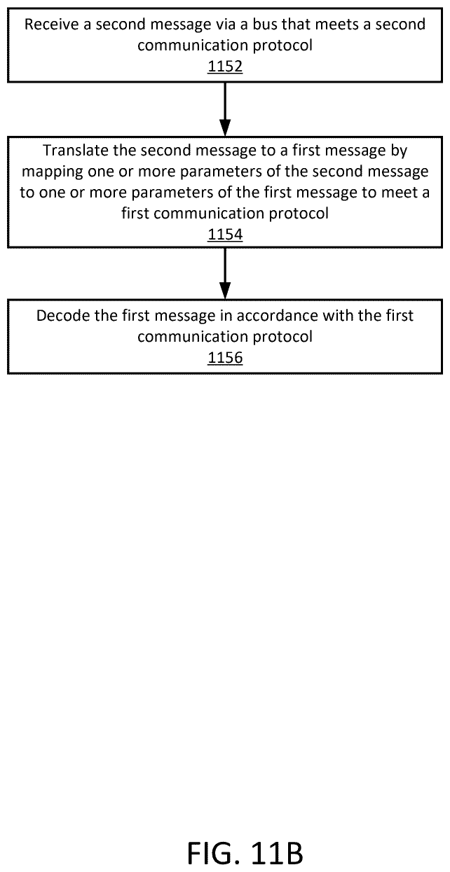

FIGS. 11A-11B illustrate example process flows, in accordance with an embodiment of the disclosure. With reference to FIGS. 11A and 11B, the process flows 1100, 1150 may comprise respective methods executed by and/or otherwise associated with any suitable number and/or type of components such as one or more processors (processing circuitry), hardware components, executed instructions (e.g., software components) or combinations of these. The components may, for example, be associated with one or more components of the node 200 and/or the node 800 as discussed herein. Alternatively, such components may be associated with a separate device, such as a bridge for instance, as noted herein. The flows 1100, 1150 may include alternate or additional blocks that are not shown in FIGS. 11A-11B for purposes of brevity, and may be performed in a different order than shown. Moreover, some blocks may be optional. Additionally, any of the statements made with respect to the operation of the nodes 200, 800 are also applicable to the process flow as discussed herein with respect to FIGS. 11A-11B.

With respect to FIG. 11A, the process flow 1100 may begin with the generation (block 1102) of one or more first messages. This may include, for example, generating a secured or unsecured message in accordance with any suitable communication protocol. For instance, the first message may be generated in accordance with an Ethernet protocol such as 10BASE-T1S or 10BASE-T1L. The message may be additionally or alternatively generated as a secure message by leveraging the IKAsec or MACsec security protocols, as discussed herein for instance with respect to FIGS. 9A and 9B, to generate the secured Ethernet frames 910, 930. Alternatively, this may include generating (block 1102) an unsecured Ethernet frame, as discussed herein for instance with respect to FIG. 9C for the Ethernet frame 950.

The process flow 1100 further comprises translating (block 1104) the first message to a second message, which may include mapping the various fields of the first message to fields that are associated with the second communication protocol to be used for the generation of the second message. This may include, for instance, the use of any of the mapping functions discussed herein, such as the CAN ID mapping performed via the CAN ID mapper 911, the SecTAG mapping performed by the SecTAG mapper 913, mapping the KN of one message to another, mapping the ICV of one message to another, etc. The translation (block 1104) may include storing the results of each mapping process that is performed in this manner in a suitable memory (e.g. the volatile or non-volatile memory 204/804, 206/806, etc.

The process flow 1100 further comprises generating (block 1106) the second message in accordance with a second communication protocol. This may include, for instance, retrieving the translated values from a suitable memory location to then generate the second message with fields corresponding to these calculated values. This may include for example generating a secured or unsecured second message in accordance with any suitable communication protocol. For instance, the second message may be generated in accordance with a CAN bus protocol, such as CAN, CAN XL, CAN FD, etc., for example. The second message may thus be generated as a secure message by translating the secured Ethernet frames 910, 930 to a respective secured CAN frame 920, 940. Alternatively, this may include generating (block 1106) an unsecured message by translating the unsecured Ethernet frame 950 to a respective unsecured CAN frame 960.

The process flow 1100 further comprises transmitting (block 1108) the second message to the bus in accordance with the communication protocol identified with the second message. This may include, for instance, transmitting the second secured or unsecured CAN frame on a CAN bus, as discussed herein.

With respect to FIG. 11B, the process flow 1100 may begin with receiving (block 1152) a second message via a bus in accordance with the communication protocol identified with the first message. This may include, for instance, receiving the second secured or unsecured CAN frame message via a CAN bus, as discussed herein with respect to the transmitted (block 1108) message of the flow 1100.

The process flow 1150 further comprises translating (block 1154) the second message to a first message, which may mapping the various fields of the second message to fields that are associated with the first communication protocol. This may include, for instance, the use of any of the demapping functions discussed herein, such as the CAN ID demapping performed via the CAN ID demapper 915, the SecTAG demapping performed by the SecTAG demapper 917, mapping the KN of one message to another, mapping the ICV of one message to another, etc. The translation (block 1154) may include storing the results of each demapping process that is performed in this manner in a suitable memory (e.g. the non-volatile memory 804, the volatile memory 806, etc.

The process flow 1150 further comprises decoding (block 1156) the first message in accordance with a first communication protocol. This may include, for instance, retrieving the translated values from a suitable memory location to then generate the first message with fields corresponding to these calculated values. This may include, for example, generating a secured or unsecured first message in accordance with any suitable communication protocol. For instance, the first message may be generated in accordance with an Ethernet protocol such as 10BASE-T1S or 10BASE-T1L, for example. The message may be additionally or alternatively generated as a secure message by leveraging the IKAsec or MACsec security protocols, as discussed herein for instance with respect to FIGS. 9A and 9B, to generate the secured Ethernet frames 910, 930 from the received secured CAN frame 920, 940. The decoding process may thus include processing the first message in accordance with the first communication protocol, which may include authenticating and/or decrypting the first message. Alternatively, the second message may comprise an unsecured CAN bus frame 960, and the first message may thus correspond to an unsecured Ethernet frame, e.g. Ethernet frame 950. The decoding process may thus include processing the first message in accordance with the first communication protocol to obtain the content of the first message.

### EXAMPLES

The techniques of this disclosure may also be described in the following examples.

Example 1. A node in a system of interconnected nodes configured to communicate over a bus, the node comprising: processing circuitry configured to translate a first message in accordance with a first communication protocol to a second message in accordance with a second communication protocol by mapping one or more parameters of the first message that identify the node in accordance with the first communication protocol to one or more parameters of the second message that identify the node in accordance with the second communication protocol, wherein the first communication protocol and the second communication protocol are different than one another; and communication circuitry configured to transmit the second message to the bus.

Example 2. The node of Example 1, wherein the processing circuitry is configured to generate the first message as a first secured message based upon a cryptographic function defined in accordance with the first communication protocol.

Example 3. The node of any combination of Examples 1-2, wherein the processing circuitry is configured to generate the first secured message by encrypting content of the first message based upon the cryptographic function defined in accordance with the first communication protocol to generate the first secured message as an authenticated and encrypted message.

Example 4. The node of any combination of Examples 1-3, wherein the processing circuitry is configured to generate the first secured message as an authentication only message.

Example 5. The node of any combination of Examples 1-4, wherein the communication circuitry is configured to receive the first message via the bus in accordance with the first communication protocol.

Example 6. The node of any combination of Examples 1-5, wherein the first message comprises an Ethernet communication protocol frame.

Example 7. The node of any combination of Examples 1-6, wherein the second message comprises one of a Controller Area Network (CAN) communication protocol frame, a Controller Area Network Flexible Data-Rate (CAN FD) communication protocol frame, a Controller Area Network Extra Long (CAN XL) communication protocol frame a FlexRay communication protocol frame, or a local interconnect network (LIN) communication frame.

Example 8. The node of any combination of Examples 1-7, wherein the one or more parameters of the first message comprise a source address and port identifier, and wherein the one or more parameters of the second message comprise a Controller Area Network identifier (CAN ID) that identifies the node.

Example 9. A node in a system of interconnected nodes configured to communicate over a bus, the node comprising: processing circuitry configured to: translate a first message in accordance with a first communication protocol to a second message in accordance with a second communication protocol by mapping one or more parameters of the first message to one or more parameters of the second message, wherein the second communication protocol is different than the first communication protocol; and process content of the first message in accordance with the second communication protocol.

Example 10. The node of Example 9, further comprising: communication circuitry configured to receive the first message via the bus in accordance with the first communication protocol.

Example 11. The node of combination of Examples 9-10, wherein the processing circuitry is further configured to authenticate and decrypt content of the first message based upon a cryptographic function defined in accordance with the second communication protocol.

Example 12. The node of any combination of Examples 9-11, wherein the processing circuitry is further configured to authenticate only content of the first message based upon a cryptographic function defined in accordance with the second communication protocol.

Example 13. The node of any combination of Examples 9-12, wherein the first communication protocol comprises one of a Controller Area Network (CAN) communication protocol, a Controller Area Network Flexible Data-Rate (CAN FD) communication protocol, a Controller Area Network Extra Long (CAN XL) communication protocol a FlexRay communication protocol, or a local interconnect network (LIN) communication.

Example 14. The node of any combination of Examples 9-13, wherein the second communication protocol comprises an Ethernet protocol.

Example 15. The node of any combination of Examples 9-14, wherein the Ethernet protocol comprises a 10BASE-T1S or a 10BASE-T1L Ethernet protocol.

Example 16. The node of any combination of Examples 9-15, wherein the processing circuitry is configured to map the one or more parameters of the first message to one or more parameters of the second message.

Example 17. The node of any combination of Examples 9-16, wherein the one or more parameters of the second message comprise a source address and port identifier, and wherein the one or more parameters of the first message comprise a Controller Area Network identifier (CAN ID) that identifies the node.

Example 18. A method, comprising: translating a first message in accordance with a first communication protocol to a second message in accordance with a second communication protocol by mapping (i) one or more parameters of the first message that identify a transmitting node in accordance with a first communication protocol to (ii) one or more parameters of the second message that identify the transmitting node in accordance with the second communication protocol, wherein the first communication protocol and the second communication protocol are different from one another.

Example 19. The method of Example 18, wherein content of the first message is secured using a security protocol that is defined in accordance with the first communication protocol to provide a secured first message.

Example 20. The method of any combination of Examples 18-19, wherein the first secured message comprises an authenticated and encrypted message.

Example 21. The method of any combination of Examples 18-20, wherein the first secured message comprises an authentication only message.

Example 22. The method of any combination of Examples 18-21, wherein content of the first message is secured using a security protocol that is defined in accordance with a third communication protocol having a higher layer security with respect to the first communication protocol.

Example 23. The method of any combination of Examples 18-22, further comprising: transmitting the second message to a bus.

Example 24. The method of any combination of Examples 18-23, further comprising: receiving the first message from a bus.

Example 25. The method of any combination of Examples 18-24, wherein the one or more parameters of the first message that identify the transmitting node in accordance with the first communication protocol comprise a source address and a port number.

Example 26. The method of any combination of Examples 18-25, wherein the one or more parameters of the second message that identify the transmitting node in accordance with the second communication protocol comprise a Controller Area Network identifier (CAN ID).

Example 27. The method of any combination of Examples 18-26, wherein one of the first message or the second message is secured using Media Access Control Security (MACsec).

Example 28. The method of any combination of Examples 18-27, wherein one of the first message or the second message is generated in accordance with a Controller Area Network (CAN), communication protocol, a CAN Flexible Data-Rate (CAN FD), or a CAN Extended Length (CAN XL) communication protocol.

An apparatus as shown and described.

A method as shown and described.

### CONCLUSION

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation data. The term “information” may in addition to any form of digital information also include other forms of representing information. The term “entity” or “unit” may in embodiments include any device, apparatus circuits, hardware, software, firmware, chips, or other semiconductors as well as logical units or physical implementations of protocol layers etc. Furthermore, the terms “coupled” or “connected” may be interpreted in a broad sense not only covering direct but also indirect coupling.

It is further to be noted that methods disclosed in the specification or in the claims may be implemented by a device having means for performing each of the respective steps of these methods.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

What is claimed is:

1. A node in a system of interconnected nodes configured to communicate over a bus, the node comprising:
processing circuitry configured to translate a first message in accordance with a first communication protocol to a second message in accordance with a second communication protocol by mapping one or more parameters of the first message that identify the node in accordance with the first communication protocol to one or more parameters of the second message that identify the node in accordance with the second communication protocol,
wherein the first communication protocol and the second communication protocol are different than one another; and
communication circuitry configured to transmit the second message to the bus.

2. The node of claim 1, wherein the processing circuitry is configured to generate the first message as a first secured message based upon a cryptographic function defined in accordance with the first communication protocol.

3. The node of claim 2, wherein the processing circuitry is configured to generate the first secured message by encrypting content of the first message based upon the cryptographic function defined in accordance with the first communication protocol to generate the first secured message as an authenticated and encrypted message.

4. The node of claim 2, wherein the processing circuitry is configured to generate the first secured message as an authentication only message.

5. The node of claim 1, wherein the communication circuitry is configured to receive the first message via the bus in accordance with the first communication protocol.

6. The node of claim 1, wherein the first message comprises an Ethernet communication protocol frame.

7. The node of claim 1, wherein the second message comprises one of a Controller Area Network (CAN) communication protocol frame, a Controller Area Network Flexible Data-Rate (CAN FD) communication protocol frame, a Controller Area Network Extra Long (CAN XL) communication protocol frame a FlexRay communication protocol frame, or a local interconnect network (LIN) communication frame.

8. The node of claim 1, wherein the one or more parameters of the first message comprise a source address and port identifier, and
wherein the one or more parameters of the second message comprise a Controller Area Network identifier (CAN ID) that identifies the node.

9. A node in a system of interconnected nodes configured to communicate over a bus, the node comprising:
processing circuitry configured to:
translate a first message in accordance with a first communication protocol to a second message in accordance with a second communication protocol by mapping one or more parameters of the first message to one or more parameters of the second message,
wherein the second communication protocol is different than the first communication protocol; and
process content of the first message in accordance with the second communication protocol.

10. The node of claim 9, further comprising:
communication circuitry configured to receive the first message via the bus in accordance with the first communication protocol.

11. The node of claim 9, wherein the processing circuitry is further configured to authenticate and decrypt content of the first message based upon a cryptographic function defined in accordance with the second communication protocol.

12. The node of claim 9, wherein the processing circuitry is further configured to authenticate only content of the first message based upon a cryptographic function defined in accordance with the second communication protocol.

13. The node of claim 9,
wherein the first communication protocol comprises one of a Controller Area Network (CAN) communication protocol, a Controller Area Network Flexible Data-Rate (CAN FD) communication protocol, a Controller Area Network Extra Long (CAN XL) communication protocol a FlexRay communication protocol, or a local interconnect network (LTN) communication.

14. The node of claim 9, wherein the second communication protocol comprises an Ethernet protocol.

15. The node of claim 14, wherein the Ethernet protocol comprises a 10BASE-T1S or a 10BASE-T1L Ethernet protocol.

16. The node of claim 9, wherein the processing circuitry is configured to map the one or more parameters of the first message to one or more parameters of the second message.

17. The node of claim 9, wherein the one or more parameters of the second message comprise a source address and port identifier, and
wherein the one or more parameters of the first message comprise a Controller Area Network identifier (CAN ID) that identifies the node.

18. A method, comprising:
translating a first message in accordance with a first communication protocol to a second message in accordance with a second communication protocol by mapping (i) one or more parameters of the first message that identify a transmitting node in accordance with a first communication protocol to (ii) one or more parameters of the second message that identify the transmitting node in accordance with the second communication protocol,
wherein the first communication protocol and the second communication protocol are different from one another.

19. The method of claim 18, wherein content of the first message is secured using a security protocol that is defined in accordance with the first communication protocol to provide a secured first message.

20. The method of claim 19, wherein the first secured message comprises an authenticated and encrypted message.

21. The method of claim 19, wherein the first secured message comprises an authentication only message.

22. The method of claim 18, wherein content of the first message is secured using a security protocol that is defined in accordance with a third communication protocol having a higher layer security with respect to the first communication protocol.

23. The method of claim 18, further comprising:
transmitting the second message to a bus.

24. The method of claim 18, further comprising:
receiving the first message from a bus.

25. The method of claim 18, wherein the one or more parameters of the first message that identify the transmitting node in accordance with the first communication protocol comprise a source address and a port number.

26. The method of claim 18, wherein the one or more parameters of the second message that identify the transmitting node in accordance with the second communication protocol comprise a Controller Area Network identifier (CAN ID).

27. The method of claim 18, wherein one of the first message or the second message is secured using Media Access Control Security (MACsec).

28. The method of claim 18, wherein one of the first message or the second message is generated in accordance with a Controller Area Network (CAN), communication protocol, a CAN Flexible Data-Rate (CAN FD), or a CAN Extended Length (CAN XL) communication protocol.
